(19) United States
(12) Patent Application Publication
(10) Pub. No.: US 2018/0053180 A1
(43) Pub. Date: Feb. 22, 2018

(54) MOBILE TERMINAL AND METHOD FOR CONTROLLING THE SAME

(71) Applicant: LG ELECTRONICS INC., Seoul (KR)

(72) Inventors: Taehoon CHO, Seoul (KR); Sanghyun EIM, Seoul (KR)

(73) Assignee: LG ELECTRONICS INC., Seoul (KR)

(21) Appl. No.: 15/380,975

(22) Filed: Dec. 15, 2016

(30) Foreign Application Priority Data
Aug. 19, 2016 (KR) 10-2016-0105446

(51) Int. Cl. G06Q 20/34; G07F 7/08; G06K 19/07

(52) U.S. Cl. CPC G06Q 20/353; G07F 7/0873; G06Q 20/3572; G06Q 20/341; G06K 19/0723

(57) ABSTRACT

A mobile terminal includes: a wireless communication unit for receiving information of a card inserted into a card module capable of recognizing the inserted card from the card module; a display unit for outputting an execution screen of an application capable of setting an amount of money available for each of a plurality of cards; and a controller for setting the amount of money available for each of the plurality of cards, based on that a preset user input is applied to the execution screen of the application, wherein, if one of the plurality of cards is inserted into the card module in a charge mode of the card module, the card module transfers an amount of money set to be available in the inserted card from a preset account to an account corresponding to the inserted card, so that the amount of money is available in the inserted card.

### CROSS-REFERENCE TO RELATED APPLICATIONS

Pursuant to 35 U.S.C. § 119(a), this application claims the benefit of earlier filing date and right of priority to Korean Patent Application No. 10-2016-0105446, filed on Aug. 19, 2016, the contents of which are all hereby incorporated by reference herein in its entirety.

### BACKGROUND OF THE INVENTION

1. Field of the Invention

The present disclosure relates to a mobile terminal capable of communicating with a card module and a method for controlling the mobile terminal.

2. Description of the Conventional Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions may include data and voice communications, capturing images and video through a camera, recording audio, playing music files through a speaker system, and displaying images and video on a display unit. Some mobile terminals additionally provide functions such as playing an electronic game, or executing a function of multimedia players. Especially, recent mobile terminals may receive multicast signal for providing visual content such as broadcasts, videos, or television programs.

As it becomes multifunctional, a mobile terminal can be allowed to capture still images or moving images, play music or video files, play games, receive broadcast and the like, so as to be implemented as an integrated multimedia player.

Meanwhile, with the development of fintech services in which finance and technology are fused and mixed, payment services through mobile terminals have appeared. Such payment services have been developed as various services from mobile simple payment services based on hardware to simple payment services based on apps (applications).

As one of the mobile simple payment services based on hardware, there is provided an all-in-one card service in which information on several cards is stored in one card, and a payment is performed using the one card.

Meanwhile, as the payment method is diversified as described above, it is difficult to collectively manage money flow in a specific group (e.g., a family, etc.) that requires integrated management.

For example, as persons to be managed perform payments in various payment methods including general credit cards, all-in-one cards, cash, and the like, it is difficult to detect the total amount of spending money.

### SUMMARY OF THE INVENTION

Therefore, an aspect of the detailed description is to provide a mobile terminal that enables an amount of money set to be paid to a card to be charged when the corresponding card is inserted into a card module, and a method for controlling the mobile terminal.

To achieve these and other advantages and in accordance with the purpose of this specification, as embodied and broadly described herein, a mobile terminal includes: a wireless communication unit configured to receive information of a card inserted into a card module capable of recognizing the inserted card from the card module; a display unit configured to output an execution screen of an application capable of setting an amount of money available for each of a plurality of cards; and a controller configured to set the amount of money available for each of the plurality of cards, based on that a preset user input is applied to the execution screen of the application, wherein, if one of the plurality of cards is inserted into the card module in a charge mode of the card module, the card module transfers an amount of money set to be available in the inserted card from a preset account to an account corresponding to the inserted card, so that the amount of money is available in the inserted card.

In one exemplary embodiment, in the case of at least one of when the distance between the mobile terminal and the card module is within a preset distance, when a preset touch input is applied to an icon of the application, and when a preset master card is inserted into the card module, the controller may output the execution screen of the application.

In one exemplary embodiment, the controller may output, on the execution screen of the application, at least one of lists of the plurality of cards or card users, the amounts of money set to be available, and amounts of money currently remaining after use for each of the plurality of cards or the card users.

In one exemplary embodiment, the controller may output, on the execution screen of the application, data obtained by analyzing expenditure details of amounts of money used by the plurality of cards on the basis of a preset reference.

In one exemplary embodiment, the controller may exclude some cards or some card users from the lists of the plurality of cards or the card users, based on that a preset user input is applied to the some cards or the some card users in the lists of the plurality of cards or the card users.

In one exemplary embodiment, the controller may receive information of a new card except the plurality of cards from the card module, based on that the new card is inserted into the card module, and add the new card to the lists of the plurality of cards or the card users.

In one exemplary embodiment, the controller may set a fixed amount of money to be transferred to an account corresponding to a selected card and a period in which the fixed amount of money is to be transferred to the account corresponding to the selected card, based on that a preset user input is applied to the execution screen of the application.

In one exemplary embodiment, based on at least one of the plurality of cards is used, the controller may output a notification message to check an expenditure detail of an amount of money used by the card.

In one exemplary embodiment, the controller may restrict the use of a selected card, based on that a preset user input is applied to the execution screen of the application.

In one exemplary embodiment, the controller may output a conversation window to communicate messages with a mobile terminal of a selected card user, based on a preset user input is applied to the execution screen of the application.

In one exemplary embodiment, the controller may change the amount of money set to be available for each of the plurality of cards, based on a preset user input is applied to the execution screen of the application.

In one exemplary embodiment, the amount of money available for each of the plurality of cards may include a fixed amount of money, which is a specific amount of money automatically set for every specific period, and a variable amount of money, which is an amount of money temporarily set by a user input.

In one exemplary embodiment, if one of the plurality of cards is inserted into the card module in a return mode of the card module, the controller may output, on the execution screen of the application, a message notifying that an amount of money remaining after user in the set amount of money has been returned, based on that the amount of money remaining after user is returned from an account corresponding to the inserted card to the preset account.

In one exemplary embodiment, based on that an amount of money remaining after use is not returned from a card in which the amount of money remaining after user exists within a preset period, the controller may transmit a message for return request to a mobile terminal of a user of the card.

In one exemplary embodiment, based on that an amount of money remaining after use is not returned from a card in which the amount of money remaining after user exists within a preset period, the controller may subtract the amount of money not returned from a fixed amount of money, which is a specific amount of money transferred to an account corresponding to the card for every specific period.

In one exemplary embodiment, the controller may output a process in which a payment is performed by a card inserted into the card module, based on a user input for selecting a payment performed by the card module is applied.

In one exemplary embodiment, the card module may include a card information reader unit configured to receive information of a card inserted thereinto.

In one exemplary embodiment, the card module may be set to one mode among, based on that a preset user input is applied, a charge mode for allowing an amount of money to be transferred from the preset account to an account corresponding to the inserted card, a return mode for allowing an amount of money to be returned from the account corresponding to the inserted card to the preset account, and a payment mode for allowing a payment to be performed by the inserted card.

In one exemplary embodiment, the card module may include an output unit configured to display the set mode.

To achieve these and other advantages and in accordance with the purpose of this specification, as embodied and broadly described herein, a method for controlling a mobile terminal includes: setting an amount of money available for each of a plurality of cards, based on that a preset user input is applied to an execution screen of an application capable of setting the amount of money available for each of the plurality of cards; and receiving information of a card inserted into a card module capable of recognizing the inserted card from the card module, wherein the receiving of the information of the inserted card from the card module includes, if one of the plurality of cards is inserted in a charge mode of the card module, transferring an amount of money set to be available in the inserted card from a preset account to an account corresponding to the inserted card, so that the amount of money is available in the inserted card.

Further scope of applicability of the present application will become more apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from the detailed description.

### BRIEF DESCRIPTION OF THE DRAWING

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram of a mobile terminal according to an exemplary embodiment;

FIGS. 1B and 1C are conceptual diagrams illustrating an example of the mobile terminal, viewed in different directions, according to the exemplary embodiment;

FIG. 2A is a conceptual diagram illustrating an example of a card module and a cover according to the exemplary embodiment;

FIGS. 2B and 2C are conceptual diagrams examples of the card module and the cover, viewed in different directions, according to the exemplary embodiment;

FIG. 2D is a conceptual diagram illustrating an exemplary embodiment in which a card is inserted into the card module;

FIG. 2E is a conceptual diagram illustrating an exemplary embodiment in which a card is inserted in a state in which the card module and the cover are coupled to each other;

FIG. 2F is a conceptual diagram illustrating an exemplary embodiment in which the card module and the mobile terminal are coupled to each other;

FIG. 3 is a flowchart illustrating a method for controlling the mobile terminal according to the exemplary embodiment;

FIG. 4 is a conceptual diagram illustrating exemplary embodiments in which the execution of a family account management application is started;

FIG. 5 is a conceptual diagram illustrating an exemplary embodiment of a main execution screen of the family account management application;

FIG. 6 is a conceptual diagram illustrating an exemplary embodiment in which a person to be managed is deleted;

FIGS. 7 and 8 are conceptual diagrams illustrating an exemplary embodiment in which a person to be managed is added;

FIG. 9 is a conceptual diagram illustrating another exemplary embodiment in which a person to be managed is added;

FIG. 10 is a conceptual diagram illustrating another exemplary embodiment of the main execution screen of the family account management application;

FIG. 11 is a conceptual diagram illustrating another exemplary embodiment in which a person to be managed is deleted;

FIG. 12 is a conceptual diagram illustrating still another exemplary embodiment in which a person to be managed is added;

FIG. 13 is a conceptual diagram illustrating an exemplary embodiment in which a fixed amount of money to be transferred to a person to be managed is set;

FIG. 14 is a conceptual diagram illustrating an exemplary embodiment in which an expenditure detail notification message of a person to be managed is output;

FIG. 15 is a conceptual diagram illustrating an exemplary embodiment in which the used of a card of a person to be managed is stopped;

FIGS. 16 and 17 are conceptual diagrams illustrating an exemplary embodiment in which messages are sent/received between a manager and a person to be managed;

FIG. 18 is a conceptual diagram illustrating an exemplary embodiment in which a variable amount of money to be transferred to a person to be managed is set;

FIG. 19 is a conceptual diagram illustrating an exemplary embodiment in which an amount of money remaining after use is returned from a person to be managed;

FIG. 20 is a conceptual diagram illustrating an exemplary embodiment in which a notification message notifying that an amount of money has been returned is output;

FIG. 21 is a conceptual diagram illustrating an exemplary embodiment in which a reminder message is transmitted when a person to be managed refuses to return an amount of money remaining after use;

FIG. 22 is a conceptual diagram illustrating an exemplary embodiment in which an additional amount of money is requested to be transferred in a state in which an amount of money remaining after user exists;

FIG. 23 is a conceptual diagram illustrating an exemplary embodiment in which the amount of money to be additionally transferred is replaced by the amount of money remaining after use, corresponding to the request of additionally transferring the amount of money in FIG. 22;

FIG. 24 is a conceptual view illustrating an exemplary embodiment in which a payment is performed by the card module in a state in which the mobile terminal is located close to the card module;

FIG. 25 is a conceptual diagram illustrating an exemplary embodiment in which a payment is performed by the card module in a state in which the mobile terminal is located distant from the card module;

FIGS. 26 and 27 are conceptual diagrams illustrating an exemplary embodiment in which a portion of an amount of money is shared to a person to be managed; and

FIG. 28 is a conceptual diagram illustrating an exemplary embodiment in which a returned amount of money is saved.

### DETAILED DESCRIPTION OF EXEMPLARY EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart glasses), head mounted displays (HMDs), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and a digital signage.

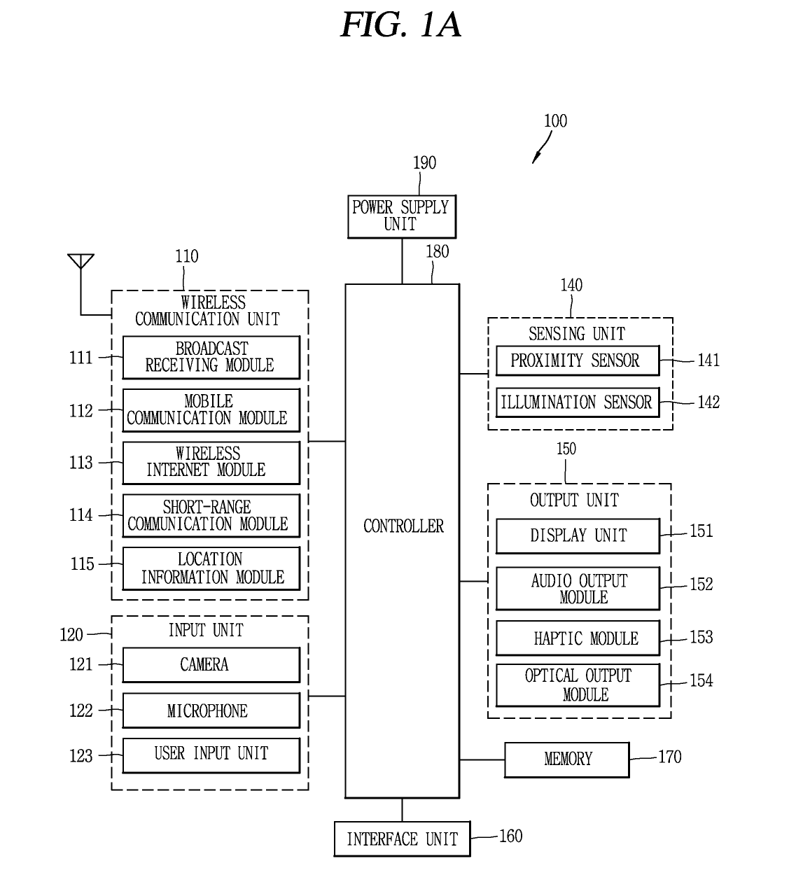

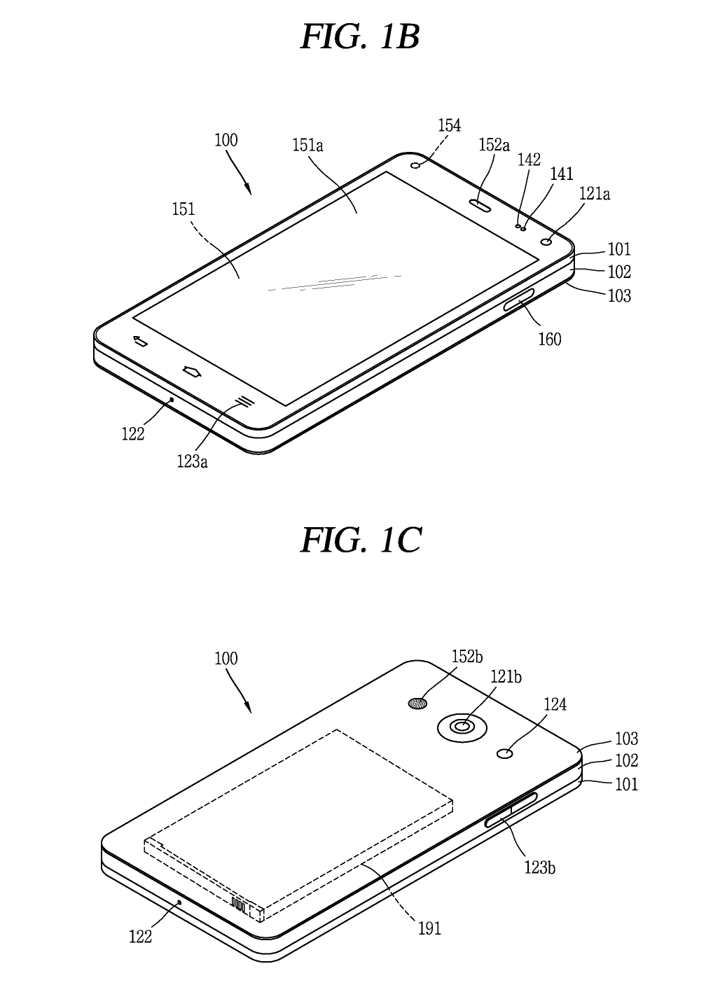

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components of FIG. 1A is not a requirement, and that greater or fewer components may alternatively be implemented.

Referring now to FIG. 1A, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), Wideband CDMA (WCDMA), High Speed Downlink Packet access (HSDPA), Long Term Evolution (LTE), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, GSM, CDMA, WCDMA, LTE and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

A magnetic sensor 143 indicates a sensor configured to detect an object approaching a predetermined surface or an object which exists nearby, and a position and a direction of the object, using a force of a magnetic field. That is, the magnetic sensor 143 indicates a sensor configured to measure a size and a direction of a peripheral magnetic field or a line of magnetic force. In the present invention, a plurality of 3-axis magnetic sensors 143a, 143b are provided at the mobile terminal 100 to more precisely sense a position and a direction of an object which generates a magnetic field.

For this, the plurality of 3-axis magnetic sensors 143a, 143b may be independent from each other, and may be spaced from each other in different directions. The controller 180 may execute a differentiated operation based on a size of a magnetic field measured by the plurality of 3-axis magnetic sensors 143a, 143b. More specifically, the controller 180 may detect a position, a direction, an angle, etc. of an object which generates a magnetic field, based on a size of a magnetic field measured by the plurality of 3-axis magnetic sensors 143a, 143b.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the mobile terminal. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

A third camera 121c may be further provided on a front surface of the terminal body. In this case, the third camera 121c may be disposed near the first camera 121a, or near the opposite side to the first camera 121a (i.e., the optical output unit 154).

The third camera 121c may be provided with a wide angle lens. In this case, the third camera 121c may support a wider viewing angle than the first camera 121a. In a general angle mode, the first camera 121a may be activated for capturing. And in a wide angle mode, the third camera 121c may be activated for capturing. An image captured by the third camera 121c may include a larger number of subjects than an image captured by the first camera 121a. However, in this case, distortion occurs toward a peripheral part of a frame.

The third camera 121c may be activated together with or independently from the first camera 121a when the first camera 121a is activated. If the third camera 121c is activated together when the second camera 121b formed on a rear surface of the terminal body is activated, an image captured by the third camera 121c may be used to compensate for a white balance reference value of an image captured by the first camera 121a.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile terminal 100 according to the present disclosure may manage a plurality of payment cards by communicating (associating) with a card module 200.

Specifically, a manager may set, through a specific application, an amount of money to be charged in a card used by a plurality of persons to be managed. After that, if the card is inserted into the card module 200, the set amount of money may be charged in the card.

Although it has been described that the card is charged, the set amount of money may be actually transmitted (transferred) from a specific account (family management account) to an account corresponding to the inserted card. The accounts may be virtual accounts or accounts existing in banks or other financial institutes.

Hereinafter, in the accompanying drawings and the following description, the specific account and the specific application are designated as a family management account (family account) and a family account management application, respectively, but the present disclosure is not limited thereto. Similarly, the persons to be managed may be designated as persons in a family, but the present disclosure is not limited thereto.

Hereinafter, the mobile terminal 100 and the card module 200 will be described with reference to the accompanying drawings. The mobile terminal 100 is mainly described as a terminal of a manager (master), but the present disclosure is not limited thereto. In some exemplary embodiments, some functions may be executed in a terminal of a person to be managed.

First, the card module 200 may include a card information reader unit capable of receiving information of a card inserted into the card module 200.

As another exemplary embodiment, the card module 200 may be set to one mode among, based on that a preset user input is applied, a charge mode for allowing an amount of money to be transferred from a preset account to an account corresponding to the inserted card, a return mode for allowing an amount of money to be returned from the account corresponding to the inserted card to the preset account, and a payment mode for allowing a payment to be performed by the inserted card.

As still another exemplary embodiment, the card module 200 may include an output unit for displaying the set mode.

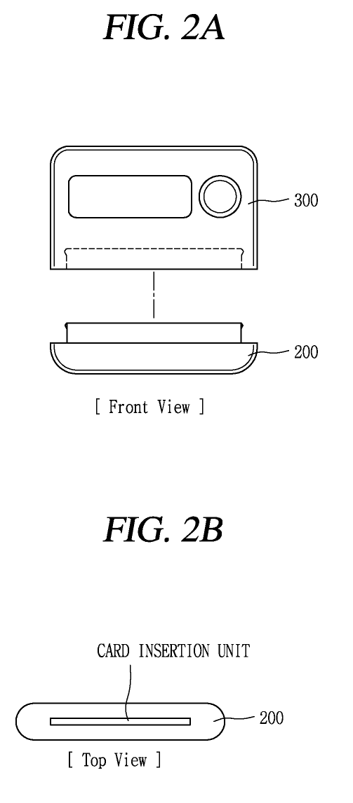

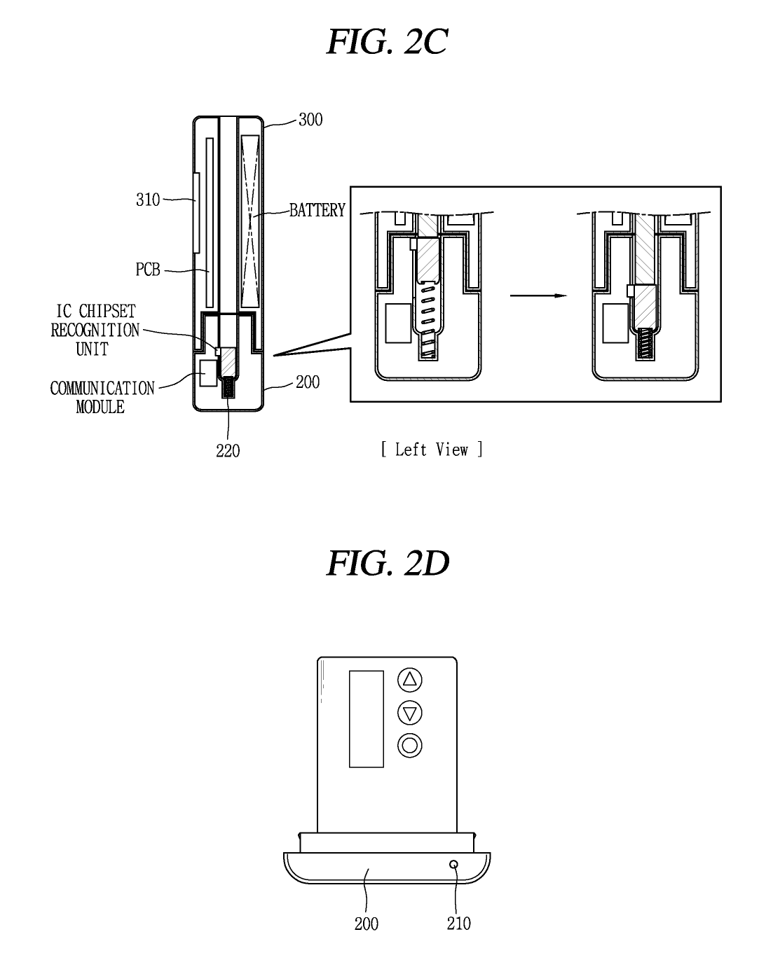

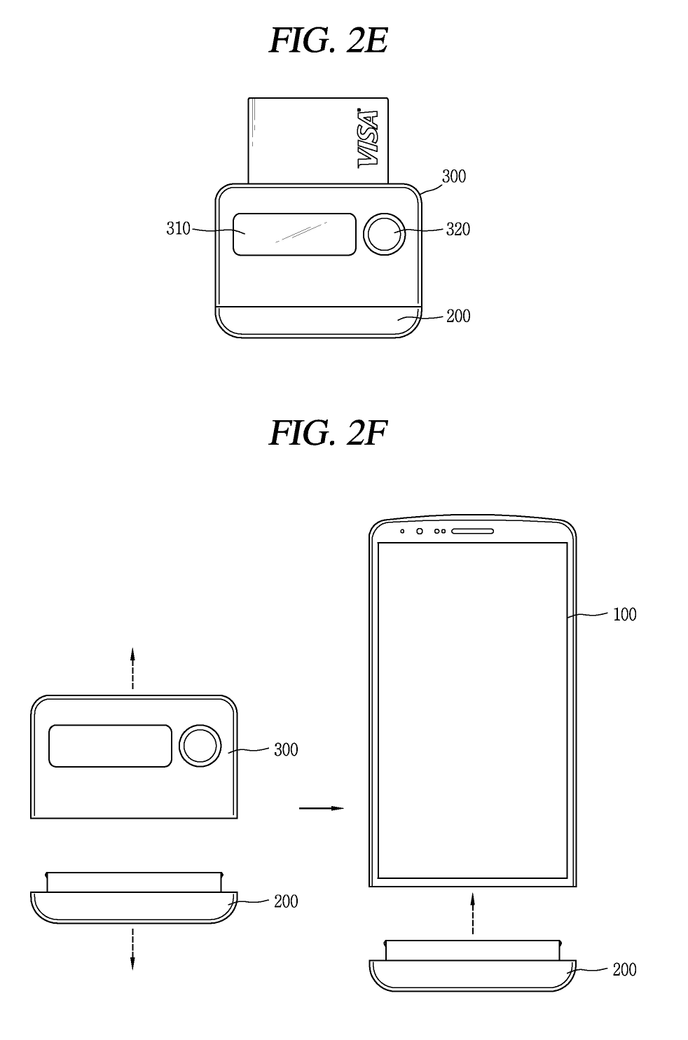

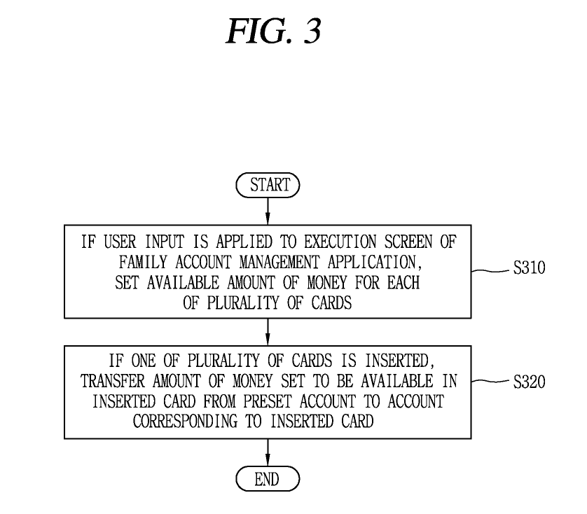

FIG. 2A is a conceptual diagram illustrating an example of a card module and a cover according to the exemplary embodiment.

Referring to FIG. 2A, the card module 200 may be coupled to a cover 300 through a coupling fixing unit. The card module according to the exemplary embodiment may mean only the card module 200, or may mean a state in which the card module 200 and the cover 300 are coupled to each other.

FIGS. 2B and 2C are conceptual diagrams examples of the card module and the cover, viewed in different directions, according to the exemplary embodiment.

Referring to FIG. 2B, the card module 200 may include a card insertion unit into which a card can be inserted by an external force.

As an exemplary embodiment, the inserted card may be a general card such as a credit card, an associated card, a discount card, a check card, a saving card, or a membership card, or may be a smart card including information on a plurality of cards.

Referring to FIG. 2C, the card module 200 may include an IC chipset recognition unit (card reader unit), a communication module, a card insertion port, and a spring 220.

As an exemplary embodiment, information of a card having an IC chip attached thereto may be read through the IC chipset recognition unit. Accordingly, both of the smart card and the general credit card can be used in the card module 200 without limitation.

As another exemplary embodiment, the card module 200 may communicate data with the mobile terminal 100 or the smart card through the communication module. Specifically, card information read to the mobile terminal 100 may be transmitted through a short-range communication network such as Bluetooth, NFC, or Wi-Fi.

As still another exemplary embodiment, after a card is inserted into the card insertion port, the spring 220 is pressed by an external force with which the card is inserted into the card insertion port. In addition, if an execution according to a selected mode among the charge mode, the return mode, or the payment mode is completed, the inserted card may be taken out as the spring 200 is restored.

FIG. 2D is a conceptual diagram illustrating an exemplary embodiment in which a card is inserted into the card module.

Referring to FIG. 2D, a general credit card or a smart card may be inserted into the card module 200.

As an exemplary embodiment, the card module 200 may include an LED lamp 210 and a display (not shown) existing separately from the cover 300.

As an exemplary embodiment, the LED lamp 210 may output light of different colors or flickered according to a selected mode among the charge mode, the return mode, or the payment mode. In addition, a selected mode among the charge mode, the return mode, or the payment mode and a progress process according thereto may be briefly displayed on the display.

Referring back to FIG. 2C, the cover 300 may include a PCB, a card insertion port, a battery, and a display 310.

FIG. 2E is a conceptual diagram illustrating an exemplary embodiment in which a card is inserted in a state in which the card module and the cover are coupled to each other.

Referring to FIG. 2E, a payment card may be inserted in the state in which the card module 200 and the cover 300 are coupled to each other. In this case, the card module 200 and the cover 300 may be disposed in the coupling state in a specific place to be used by a plurality of persons to be managed.

In addition, the display 310 and a toggle switch 320 may exist in the cover 300.

As an exemplary embodiment, one of the charge, return, and payment modes of the card module 200 may be selected through the toggle switch 320. In addition, the kind of the selected mode may be displayed on the display 310.

As a first exemplary embodiment, a card charge mode may be selected by turning the toggle switch 320. In this case, it may be displayed on the display 310 that the selected mode is the card charge mode. Subsequently, if a card is inserted, a charge amount of money set by the manager may be displayed on the display 310 to be charged in the inserted card.

After that, if the spring 220 is pressed by pushing the inserted card with a hand, the charge amount of money may be transmitted to an account corresponding to the inserted card through the communication module. That is, the set charge amount of money may be transferred (transmitted) from a family management account (family account) to the account corresponding to the inserted card. In this case, it may be displayed on the display 310 that the charge amount of money is being charged.

Next, when the hand with which the inserted card is pressed is pulled out or when the transmission of the charge amount of money is completed, the inserted card may be taken out while the spring 220 is being restored. In this case, it may be displayed on the display 310 that the charge has been completed. In addition, a notification message notifying a charge amount of money, a balance of the family account, and the like may be output to a terminal of the manager or a terminal of a user using the charged card.

As a second exemplary embodiment, a card return mode may be selected by turning the toggle switch 320. In this case, it may be displayed on the display 310 that the selected mode is the card return mode. Subsequently, if a card is inserted, an amount of money remaining in the inserted card after the inserted card (a return amount of money) may be displayed on the display 310.

After that, if the spring 220 is pressed by pushing the inserted card with a hand, the return amount of money may be transmitted to the family account through the communication module. That is, the remaining amount of money may be returned from an account corresponding to the inserted card to the family account. In this case, it may be displayed on the display 310 that the remaining amount of money is being returned.

Next, when the hand with which the inserted card is pressed is pulled out or when the return of the remaining amount of money is completed, the inserted card may be taken out while the spring 220 is being restored. In this case, it may be displayed on the display 310 that the return has been completed. In addition, a notification message notifying a return amount of money, a balance of the family account, and the like may be output in the terminal of the manager or a terminal of a user using the inserted card.

As a third exemplary embodiment, a card payment mode may be selected by turning the toggle switch 320. In this case, it may be displayed on a display 310 that the selected mode is the card payment mode. Subsequently, if a card is inserted, an amount of payment may be displayed on the display 310.

Here, the amount of payment means an amount of money, which is to be paid online in the mobile terminal 100 connected to the card module 200 through a short-range communication network such as Bluetooth.

After that, if the spring 220 is pressed by pushing the inserted card with a hand, a payment using the inserted card may be performed through the communication module. In this case, it may be displayed on the display 310 that the payment is being performed.

Next, when the hand with which the inserted card is pressed is pulled out or when the payment is completed, the inserted card may be taken out while the spring 220 is being restored. In this case, it may be displayed on the display 310 that the payment has been completed. In addition, a message notifying that the payment has been completed, a payment receipt, or the like may be output in the terminal of the manager or a terminal of a user using the inserted card.

Meanwhile, referring back to FIG. 2E, the display 310 or the toggle switch 320 may not exist in the cover 300. In this case, as control is performed through the mobile terminal 100 communicating with the card module 200 or the cover 300, user interface (UI) may be complicated, but is advantageous in terms of cost, etc.

FIG. 2F is a conceptual diagram illustrating an exemplary embodiment in which the card module and the mobile terminal are coupled to each other.

Referring to FIG. 2F, the card module 200 and the cover 300 may be separated from each other, and the mobile terminal 100 and the card module 200 may be coupled to each other.

As an exemplary embodiment, information of several cards read from the card module 200 may be transmitted to the mobile terminal 100. As a result, in the mobile terminal 100, one of the cards of which information is transmitted may be selected, thereby performing a payment, etc.

FIG. 3 is a flowchart illustrating a method for controlling the mobile terminal according to the exemplary embodiment.

Referring to FIG. 3, first, an available amount of money is set for each of a plurality of cards, based on that a preset user input is applied to an execution screen of an application capable of setting an available amount of money for each of the plurality of cards (S310).

Subsequently, information of a card inserted into a card module capable of recognizing the card inserted thereinto is received from the card module (S320).

As an exemplary embodiment, in step S320, if one of the plurality of cards is inserted in a charge module of the card module, an amount of money set to be available in the inserted card may be transferred from a preset account to an account corresponding to the inserted card, to be used in the inserted card.

Hereinafter, exemplary embodiments of the present disclosure will be described with reference to the accompanying drawings.

Meanwhile, in the case of at least one of when the distance between the mobile terminal 100 and the card module 200 is within a preset distance, the controller 180, when a preset touch input is applied to an icon of the application, and when a preset master card is inserted into the card module 200, an execution screen of the application may be output.

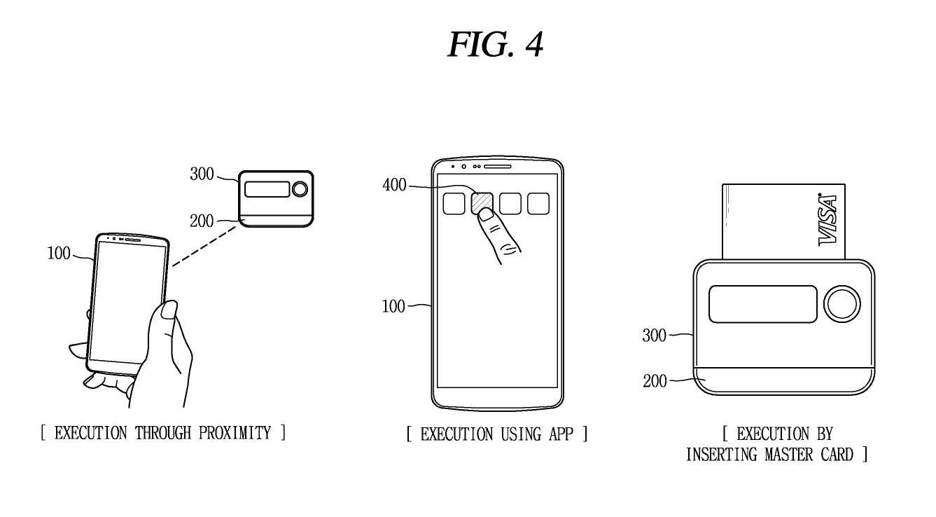

FIG. 4 is a conceptual diagram illustrating exemplary embodiments in which the execution of a family account management application is started.

Referring to FIG. 4, when the mobile terminal 100 of a master (manager) comes close to the card module 200 within 10 cm, an execution screen of the family account management application may be output on a screen 151 of the master terminal 100. That is, the family account management application may be executed.

As another exemplary embodiment, if a touch input is applied to an icon 400 of the family account management application being output on the screen 151 of the master terminal 100, an execution screen of the family account management application may be output.

As still another exemplary embodiment, if a card registered for the master to use is inserted into the card module 200, an execution screen of the family account management application may be output on the screen 151 of the master terminal 100.

As still another exemplary embodiment, the family account management application may also be executed in a mobile terminal of a person to be managed, instead of the manager.

Similarly, when a mobile terminal of a person to be managed is located from the card module 200 within a preset proximity distance, when a touch input is applied to an icon of the family account management application being output on a screen of the mobile terminal of the person to be managed, or when a card registered for the person to be managed to use is inserted into the card module 200, an execution screen of the family account management application may be output on the screen of the person to be managed.

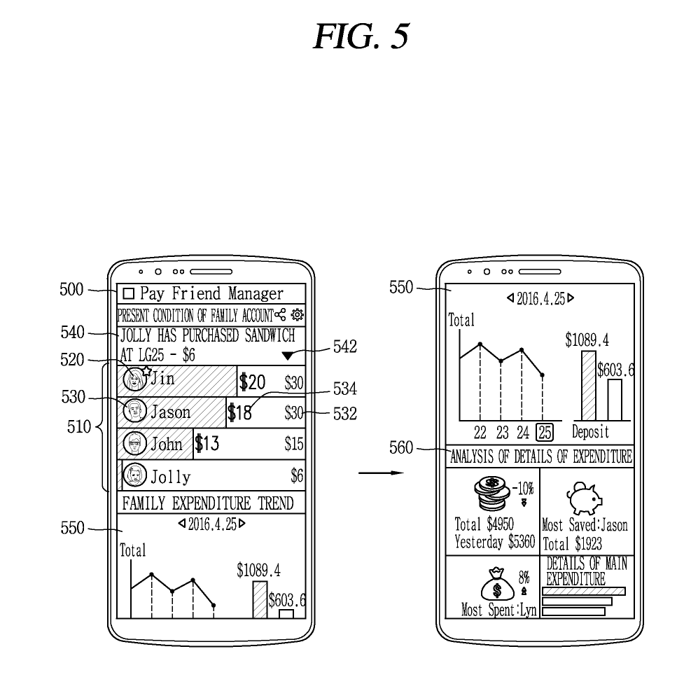

In this case, execution screens of the family account management application, which are output in the respective terminals of the master (manager) and the person to be managed may be different from each other. For example, a list of all persons to be managed may not be displayed on the execution screen of the family account management application output in the terminal of the person to be managed. An exemplary embodiment related to this will be described in FIG. 5.

Meanwhile, the controller 180 may output, on the execution screen of the application, at least one of a list of a plurality of cards or card users, a set available amount of money, and an amount of money currently remaining after use for each of the plurality of cards or card users.

As another exemplary embodiment, the controller 180 may output, on the execution screen of the application, data obtained by analyzing expenditure details of amounts of money used by the plurality of cards on the basis of a preset reference.

FIG. 5 is a conceptual diagram illustrating an exemplary embodiment of a main execution screen of the family account management application.

Referring to FIG. 5, according to the exemplary embodiments described in FIG. 4, an execution screen 500 of the family account management application may be output in the mobile terminal 100 of the master.

Specifically, a list 510 of persons to be managed may be output.

As an exemplary embodiment, a list of cards used by the persons to be managed or names, IDs, and profile pictures of the persons to be managed may be output.

As another exemplary embodiment, the name, ID, and profile picture 520 of the manager may also be output. In this case, the manager may be output with a different color, a different style of penmanship, or a different letter size or may be displayed together with a specific icon so as to be distinguished from the persons to be managed.

As still another exemplary embodiment, an amount of money set to be available and an amount of money currently remaining after use may be displayed for each of the persons to be managed. In this case, each amount of money may be displayed as a ratio graph that enables each of the persons to be managed to intuitively identify a ratio of an amount of money remaining after use with respect to the total amount of money.

Specifically, a total amount (532) of money available for a day using a card registered to a first person to be managed to use and an amount (534) of money remaining after use up to now may be displayed together with the name and profile picture (530) of the first person to be managed. In this case, as the available amount of money is decreased using the registered card, the gauge of the entire graph corresponding to the total amount 532 of money may be reduced.

As still another embodiment, a notification message 540 notifying that each of the persons to be managed has used the card in real time may be output. For example, when the person to be managed purchases a product, the message 540 notifying that the person to be managed has purchased the product may be output.

In this case, a name or ID of the person to be managed, a purchase place, a purchase product, and a purchase amount of money, and the like may be briefly output. In addition, if a touch input is applied to a detail view icon 542, more detailed information (e.g., a purchase time, etc.) related to purchase details may be output.

As still another exemplary embodiment, data 550 and 560 obtained by analyzing expenditure details of amounts of money used by the cards of the persons to be managed on the basis of a preset reference may be output.

Specifically, an amount of money used by the card of each of the persons to be managed for last few days, details 550 of amounts of money deposited to/withdrawn from the entire management account (family account), and the like may be output.

As still another exemplary embodiment, data 560 obtained by analyzing details of the amounts of money used by the cards of the persons to be managed for a specific period may be output.

Specifically, the amount of money used today may be displayed as compared with the amount of money used yesterday. Alternatively, a person to be managed, who spends the largest or smallest amount of money, may be displayed, and expenditure details may be divided for each list to be displayed.

For example, the details of the amounts of money used by the persons to be managed may be divided into lists including food expenses, online payments, transportation expenses, academy expenses, and the like to be displayed. Therefore, it may be displayed that the largest amount of money has been paid for the food expenses by comparing the amounts of money for the respective lists.

In this case, the analyzed data 550 and 560 may be output by a drag, flicking, or swipe input applied to a screen as a page is turned.

According to the exemplary embodiment of FIG. 5, the manager can manage the consumption expenditure of the persons to be managed by checking flows of money spent by the persons to be managed. Specifically, the manager has all authorities related to the control, redemption, payment, etc. of the amount of money transferred to the persons to be managed from the initial registration of the cards.

In addition, as described above, the execution screens of the family account management application, which are output in the respective terminals of the master (manager) and the persons to be managed may be different from one another.

As an exemplary embodiment, the execution screen of the family account management application, which is output in the terminal of each of the persons to be managed, may show the person to be managed or some persons to be managed among the list 510 of all of the persons to be managed. In addition, although an input for changing the available amount of money of another person to be managed is applied, the state set by the manager may be maintained.

As another exemplary embodiment, the execution screen of the family account management application, which is output in the terminal of each of the persons to be managed, may not show the notification message 540 notifying that each of the persons to be managed has used the card in real time.

As still another exemplary embodiment, the execution screen of the family account management application, which is output in the terminal of each of the persons to be managed, may not show a configuration icon for adding a new person to be managed or deleting one of the persons to be managed.

Meanwhile, the controller 180 may exclude some of a plurality of cards or some of users using the plurality of cards, based on that a preset user input is applied to some of the plurality cards or some of the users.

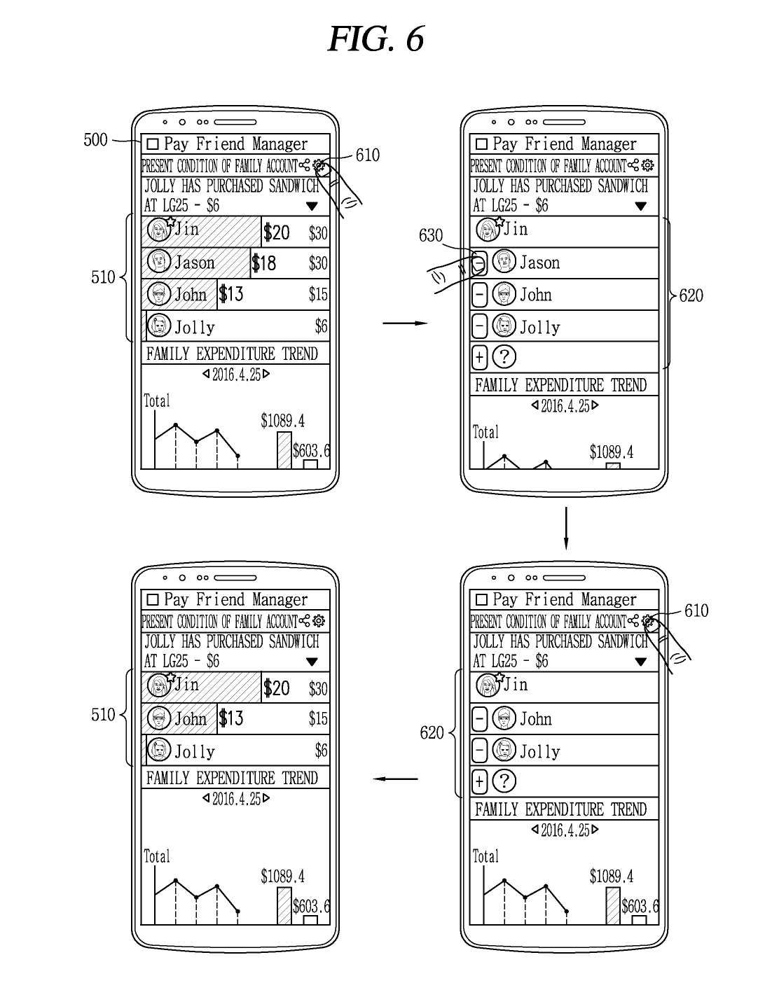

FIG. 6 is a conceptual diagram illustrating an exemplary embodiment in which a person to be managed is deleted.

Referring to FIG. 6, a touch input may be applied to a configuration icon 610 on an execution screen 500 of the family account management application in the master terminal 100.

Therefore, a setting screen 620 for deleting or adding a person to be managed may be output. As an exemplary embodiment, a deletion icon capable of deleting for each of the existing persons to be managed and an addition icon capable of adding a new person to be managed may be output.

Subsequently, if a touch input is applied to a deletion icon 630 of the first person to be managed, the first person to be managed may be deleted on the configuration screen 620. If a touch input is again applied to the configuration icon 610 after the deletion of the first person to be managed is completed, the first person to be managed may be deleted in the list 510 of all of the persons to be managed.

Meanwhile, based on that a new card except the plurality of cards is inserted into the card module 200, the controller 180 may receive information of the new card from the card module and add the new card in the list of the plurality of cards or card users.

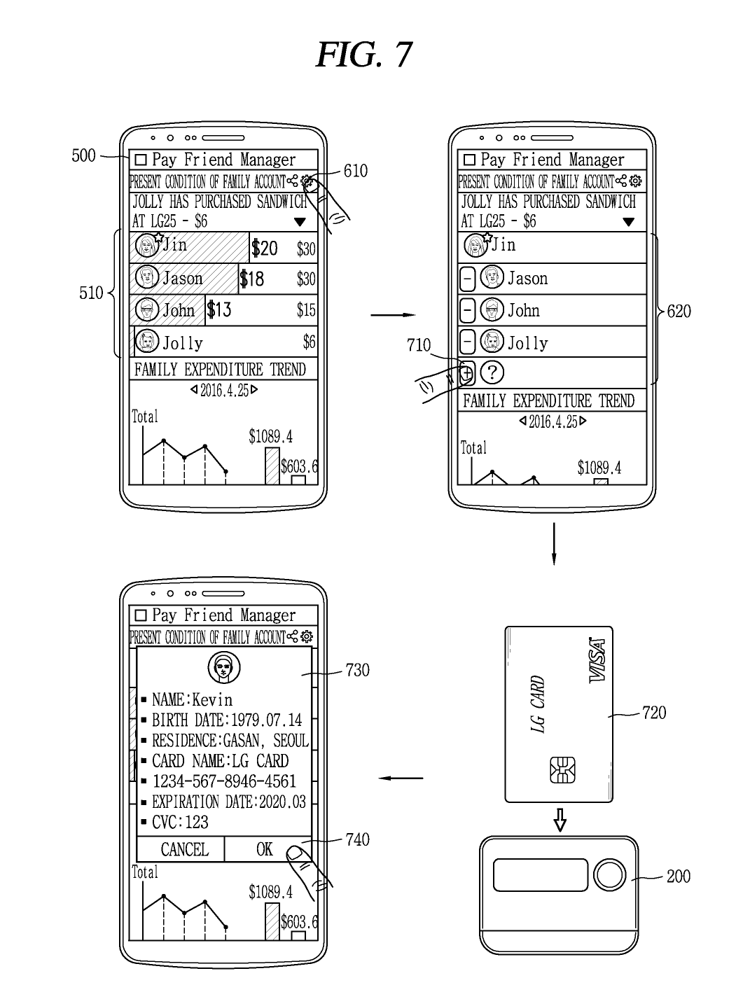

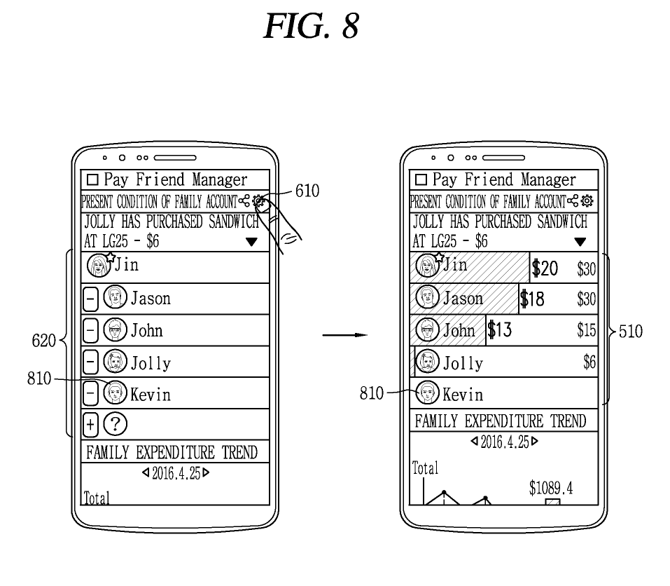

FIGS. 7 and 8 are conceptual diagrams illustrating an exemplary embodiment in which a person to be managed is added.

Referring to FIG. 7, a touch input may be applied to the configuration icon 610 on the execution screen 500 of the family account management application in the master terminal 100.

Therefore, a setting screen 620 for deleting or adding a person to be managed may be output. As an exemplary embodiment, a deletion icon capable of deleting for each of the existing persons to be managed and an addition icon capable of adding a new person to be managed may be output.

Subsequently, after a touch input is applied to an addition icon 710 capable of adding a person to be managed, a card 720 of a person to be managed, who is to be added, may be inserted into the card module 200. Therefore, a popup window 730 notifying information of the person to be added and the card 720 of the person to be added may be output on the execution screen 500 of the family account management application.

As an exemplary embodiment, a name, a profile picture, a birth data, a residence, and the like may be output as the information of the person to be added. In addition, a card name, a card number, an expiration date, CVC, and the like may be output as the information of the card used by the person to be added.

To this end, the card information reader unit of the card module 200 reads information of the inserted card and then transmits the information to the mobile terminal 100. As an exemplary embodiment, information of a credit card or smart card is read from an IC chip of the corresponding card. In addition, the information is transmitted to the mobile terminal 100 through Bluetooth, NFC, Wi-Fi, or the like.

As a result, the information of the person to be managed, which is to be added, and the card used by the person to be added is simply transmitted to the mobile terminal 100, so that it is possible to solve an inconvenience in that information of persons to be added and cards used by the persons should be registered one by one.

Subsequently, if a touch input is applied to an “OK” icon 740, the corresponding person to be managed may be added as a person to be managed.

Referring to FIG. 8, it can be seen that, as the touch input is applied to the “OK” icon 740 in FIG. 7, the added person 810 to be managed is output on the setting screen 620 for deleting or adding a person to be managed.

If a touch input is applied to the configuration icon 610 after the output of the added person 810 is completed, the added person 810 to be managed is included in the list 510 of all of the persons to be managed.

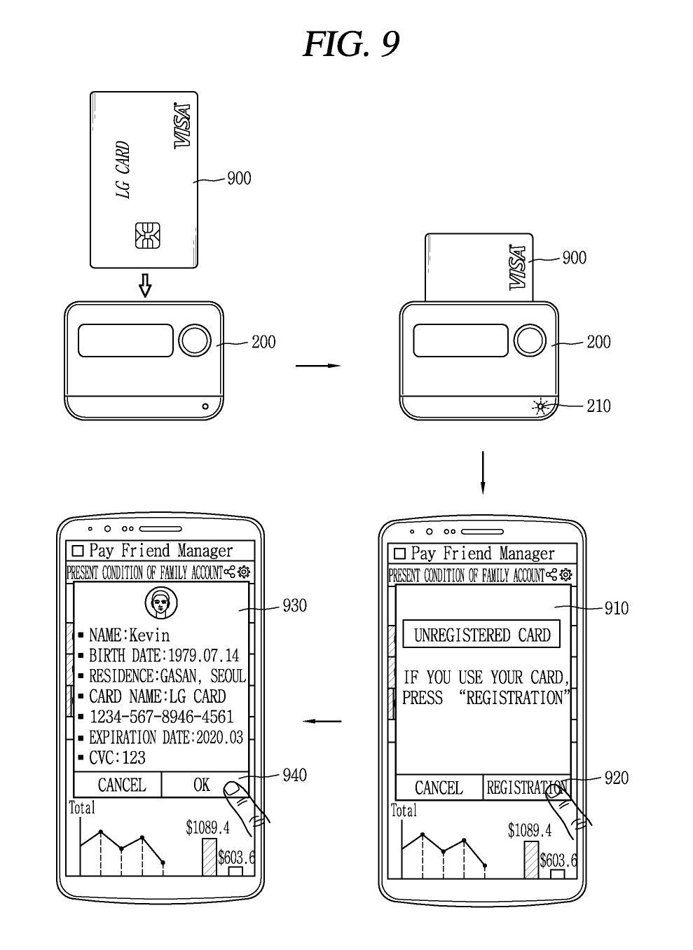

FIG. 9 is a conceptual diagram illustrating another exemplary embodiment in which a person to be managed is added.

Referring to FIG. 9, a card 900 unregistered as one the cards of the persons to be managed may be inserted into the card module 200. Therefore, light of a specific color may be output or flickered for a certain time from the LED lamp 210 of the card module 200.

To this end, the card information reader unit of the card module 200 reads information of the inserted card. For example, information of a general card or smart card is read from an IC chip of the corresponding card.

Subsequently, it is checked whether the information of the corresponding card is registered as one of the cards of the existing persons to be managed. In addition, the information is transmitted to the mobile terminal 100 through Bluetooth, NFC, Wi-Fi, or the like.

Therefore, a message popup window 910 inquiring whether a new card is to be registered may be output on the execution screen 500 of the family account management application in the mobile terminal 100.

After that, if a touch input is applied to a “registration” icon 920 and the information of the inserted card and information 930 of a card user may be output. As an exemplary embodiment, a name, a profile picture, a birth date, a residence, and the like may be output as the information of the card user. In addition, a card name, a card number, an expiration date, CVC, and the like may be output as the information of the inserted card.

After that, if a touch input is applied to an “OK” icon 940, the inserted card may be added to the list of the persons to be managed.

According to the exemplary embodiment of FIG. 9, a card is first inserted, so that a person to be managed can be easily and rapidly added. Meanwhile, such a registration plan may be restrictively set such that only previously registered users can register their cards. Specifically, it may be set that, only when a previously registered person to be managed first or additionally inserts a card to be used, the card can be registered.

Meanwhile, the main execution screen of the family account management application may be output in various ways.

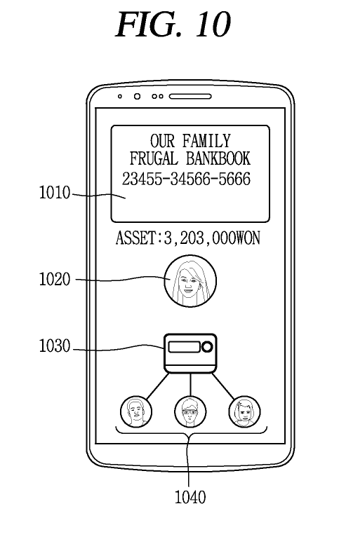

FIG. 10 is a conceptual diagram illustrating another exemplary embodiment of the main execution screen of the family account management application.

Referring to FIG. 10, if a swipe input in the left or right direction is applied to the execution screen 500 of the application described in FIG. 5, the way in which the persons to be managed are output may be changed.

As an exemplary embodiment, an icon 1010 corresponding to the preset account from which an amount of money is transferred to an account of each of the persons to be managed may be output. In addition, a name of the account, an account number, a total amount of money existing in the current account, and the like may be displayed together.

As another exemplary embodiment, as a touch input is applied to the account icon 1010, the account icon 1010 may be changed. Specifically, if a touch input is applied to the account icon 1010, a list of other selectable accounts may be output.

As still another exemplary embodiment, an icon 1020 representing the manage may be largely output, and an icon 1030 corresponding to the card module 200 may be output under the icon 1020. In addition, icons 1040 of the persons to be managed may be output by being connected to the icon 1030 of the card module 200 through lines.

That is, it can be intuitively and structurally shown that the manager manages the persons to be managed through the card module 200.

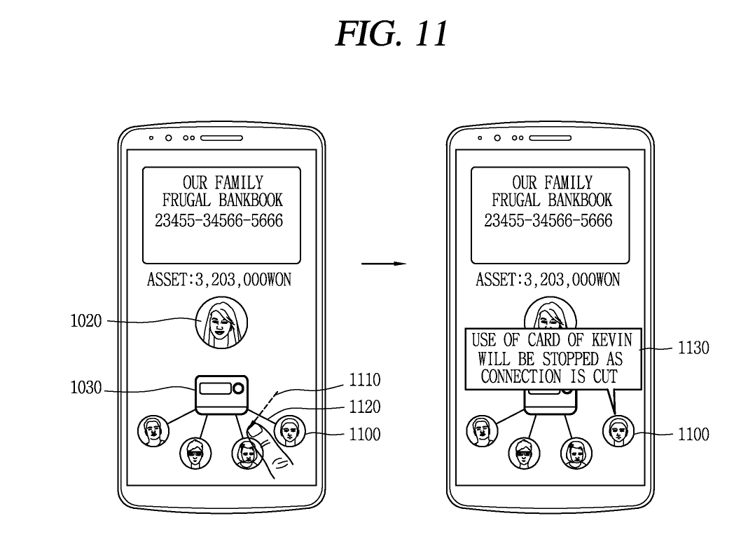

FIG. 11 is a conceptual diagram illustrating another exemplary embodiment in which a person to be managed is deleted.

Referring to FIG. 11, a flicking or drag input 1110 may be applied to a connection line 1120 connecting the icon 1030 of the card module 200 and an icon 1100 of the first person to be managed, as if the flicking or drag input 1110 cut the connection line 1120.

Therefore, the output of the connection line 1120 connecting the icon 1030 of the card module 200 and the icon 1100 of the first person to be managed may be ended. In addition, a message 1130 notifying that the use of the card of the first person to be managed is stopped because the connection is cut may be output. That is, as the connection line is cut, the card of the person to be managed is set to a stop state, and therefore, a payment, etc. cannot be performed.

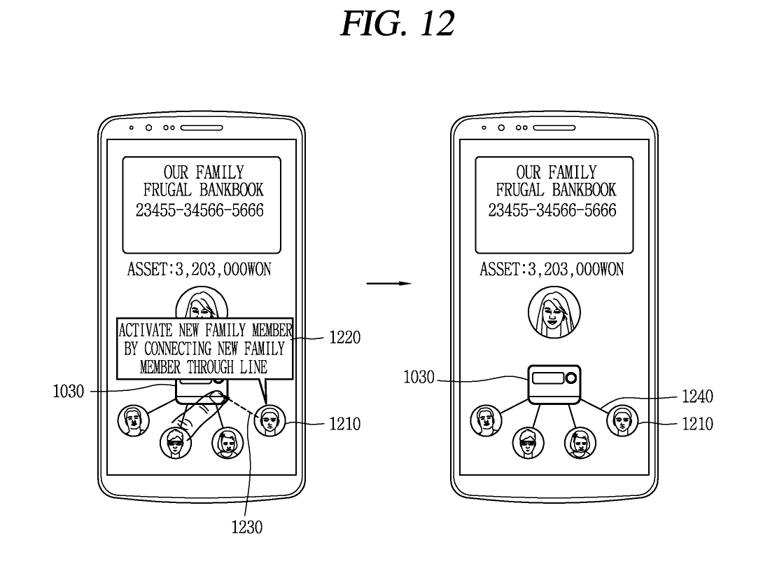

FIG. 12 is a conceptual diagram illustrating still another exemplary embodiment in which a person to be managed is added.

Referring to FIG. 12, a new person to be managed is added according to the above-described exemplary embodiments, the screen described in FIG. 10 may be output to set management.

As an exemplary embodiment, a message 1220 to activate the new person to be managed by connecting the new person to be managed through a line may be output. Therefore, a drag input 1230 to the icon 1030 of the card module 200 may be applied to an icon 1210 of the added person to be managed.

As a result, a connection line 1240 connecting the icon 1030 of the card module 200 and the icon 1210 of the added person to be managed can be output, and the manager can manage the use of a card of the added person to be managed.

Meanwhile, the controller 180 may set a period a period in which an amount of money is to be transferred to an account corresponding to the selected card and a fixed amount of money, which is to be transferred to the account, based on that a preset user input is applied to the execution screen of the application.

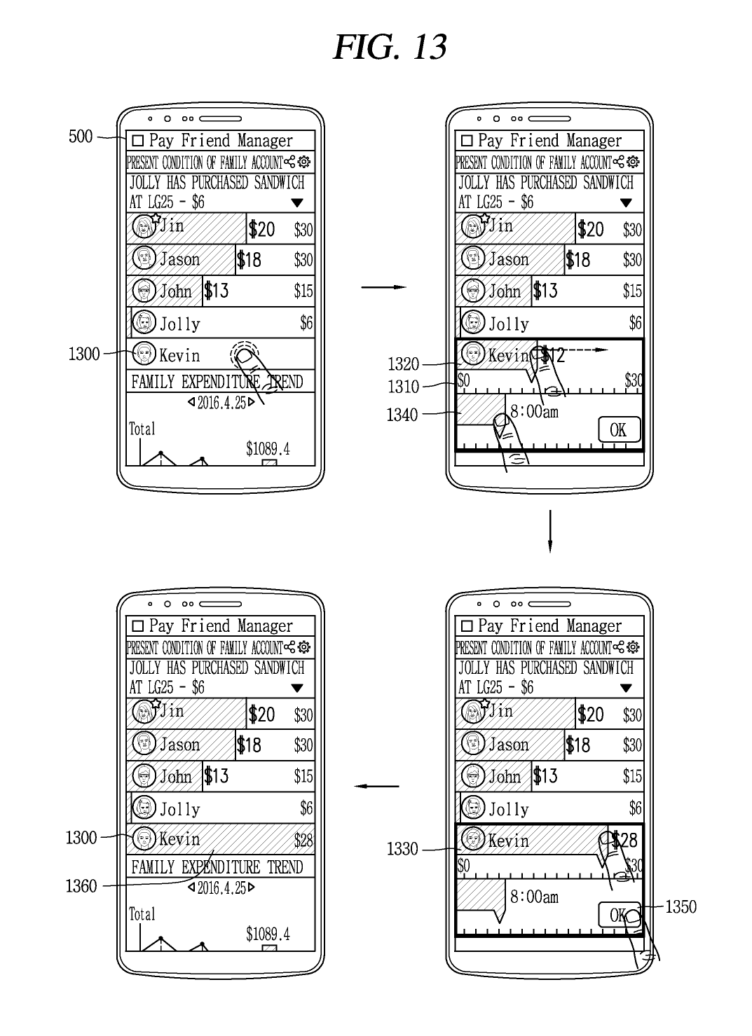

FIG. 13 is a conceptual diagram illustrating an exemplary embodiment in which a fixed amount of money to be transferred to a person to be managed is set.

Referring to FIG. 13, if a long touch input is applied to a list 1300 of the first person to be managed on the execution screen 500 of the family account management application, a window 1310 for setting a fixed amount of money to be transferred to the card of the first person to be managed may be output.

As an exemplary embodiment, as a drag input in the left/right direction is applied to a bar on which an amount of money is displayed, a fixed amount of money to be transferred to the first person to be managed everyday.

Specifically, if a long touch input is applied to a bar on which an amount of money is displayed, an amount of money ($12) and a graph 1320, which correspond to the point at which the touch input is currently applied, may be output. In addition, a strap handle capable of adjusting the amount of money may be output at which the touch input is applied.

After that, if a drag input is applied in the right direction, an amount of money ($28) and a graph 1330, which correspond to the point at which the touch input is applied, may be output. That is, the fixed amount of money may be increased by applying a drag input in the right direction, or may be decreased by applying a drag input in the left direction.

As another exemplary embodiment, if a long touch input is applied to a bar on which a time at which the fixed amount of money is to be transferred is displayed, a time (8 am) and a graph 1340, which correspond to the point at which the touch input is currently applied, may be output. In addition, a strap handle capable of adjusting the amount of money may be output at which the touch input is applied. Similarly, the time at which the fixed amount of money is to be transferred may be set by applying a drag input in the left/right direction.

If a touch input is applied to an “OK” icon 1350 after the fixed amount of money and the transfer time are set as described above, the fixed amount of the money may be displayed as a maximum value 1360 of the length of the bar displayed on the list 1300 of the first person to be managed.

Meanwhile, the time at which the fixed amount of money is transferred may be set based on that the corresponding card is inserted into the card module 200. For example, when the transfer time is set to 8 am, but the corresponding card is not inserted into the card module 200 until the set time, the fixed amount of money may not be transferred.

Meanwhile, based on that at least one of the plurality of cards is used, the controller 180 may output a notification message through which the card user can check the expenditure detail of an amount of money used by the card.

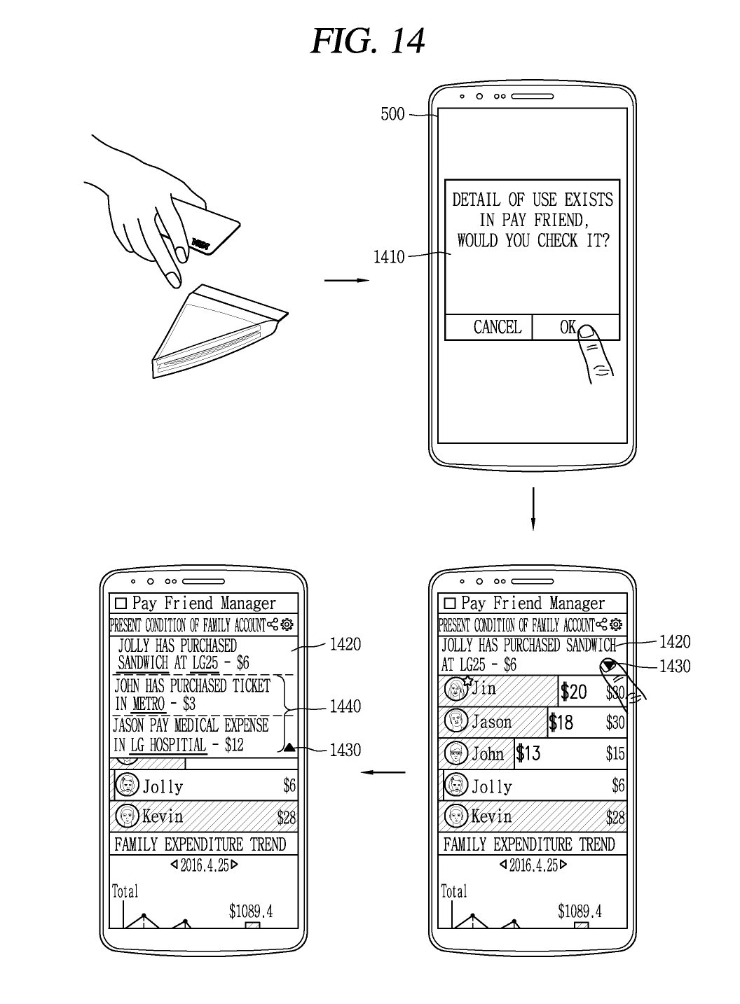

FIG. 14 is a conceptual diagram illustrating an exemplary embodiment in which an expenditure detail notification message of a person to be managed is output.

Referring to FIG. 14, when a person to be managed uses a registered card, a popup window 1410 notifying that the person to be managed has used the card may be output in the mobile terminal 100 of the master.

Therefore, if a touch input is applied to an “OK” icon, the execution screen 500 of the family account management application may be output. The list of the persons to be managed and a detail 1420 in which the person to be managed has used the card may be briefly output in real time on the execution screen 500. For example, a name of the person to be managed, a purchase place, a purchase product, and a purchase amount of money, and the like may be output.

In addition, as the person to be managed uses an amount of money, the amount of money transferred to the card of the person to be managed may be decreased by the used amount of money to be displayed. As an exemplary embodiment, an animation effect that the length of a bar displaying an available amount of money of the person to be managed is decreased by the used amount of money may be output.

As another exemplary embodiment, if a touch input is applied to a detail view icon 1430, details 1440 in which the persons to be managed have recently used their cards may be output. Similarly, names of the persons to be managed, purchase places, purchase products, purchase amounts of money, and the like may be briefly output.

As still another exemplary embodiment, if a touch input is applied to an underlined purchase place or purchase product, a search result of the relative content may be output through a hyperlink.

Specifically, if a touch input is applied to an underlined purchase place, an online site or homepage of the corresponding purchase place may be output. Alternatively, if a touch input is applied to an underlined purchase product, a page of a search site searching the corresponding product may be output.

Meanwhile, the controller 180 may limit the use of a selected card, based on that a preset user input is applied to the execution screen of the application.

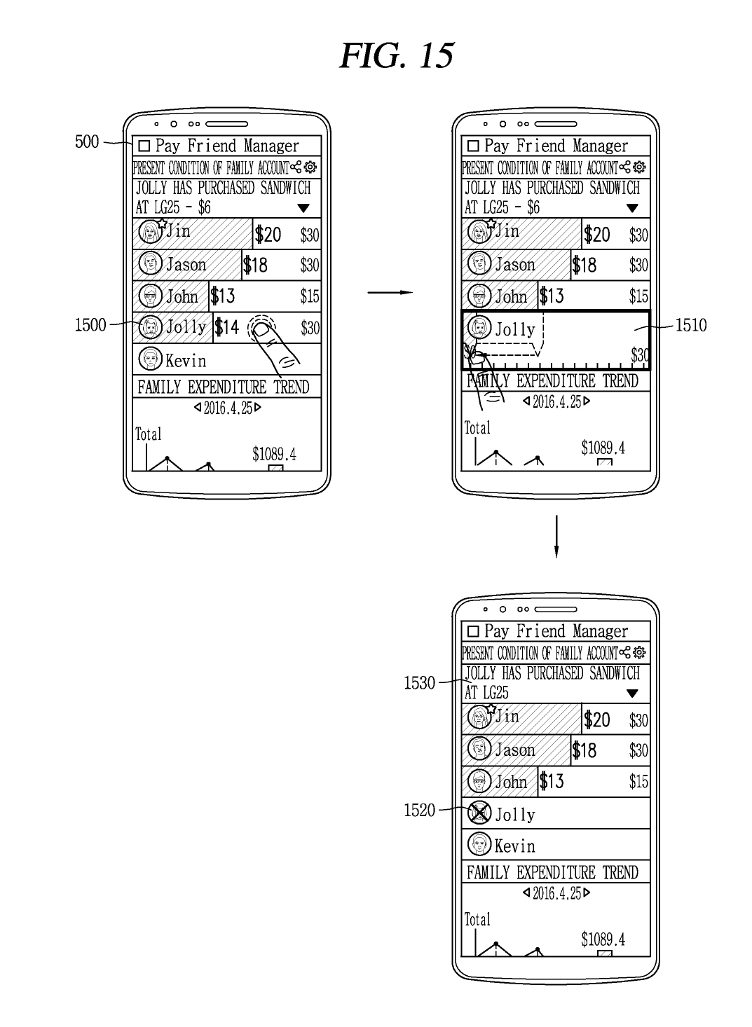

FIG. 15 is a conceptual diagram illustrating an exemplary embodiment in which the used of a card of a person to be managed is stopped.

Referring to FIG. 15, if a long touch input is applied to a list 1500 of the first person to be managed on the execution screen 500 of the family account management application, a window 1510 for changing the amount of money to be transferred to the card of the first person to be managed may be output.

As an exemplary embodiment, the available amount of money may be set to 0 by applying a drag input up to the left end of a bar on which an amount of money is displayed. Accordingly, the withdrawal of the first person to be managed is stopped, so that the first person to be managed cannot temporarily use the card. As another exemplary embodiment, a period in which the withdrawal of the first person to be managed is stopped may be set through a separate bar.

As the use of the card of the first person to be managed is temporarily stopped, an effect indicating that the use of the card of the first person to be managed has been temporarily stopped may be output. For example, the list 1500 may be dimly displayed, or an icon 1520 indicating that the use of the card of the first person to be managed has been temporarily stopped may be output.

As still another exemplary embodiment, a message 1530 notifying that the use of the card of the first person to be managed has been temporarily stopped may be output in a list indicating present conditions of the cards used in real time by the persons to be managed.

In addition, a message notifying that the use of the card of the first person to be managed has been temporarily stopped may be automatically transmitted to the mobile terminal of the first person to be managed.

Meanwhile, the controller 180 may output a conversation window through which messages can be sent to/received from a mobile terminal of a selected card user, based on that a preset user input is applied to the execution screen of the application.

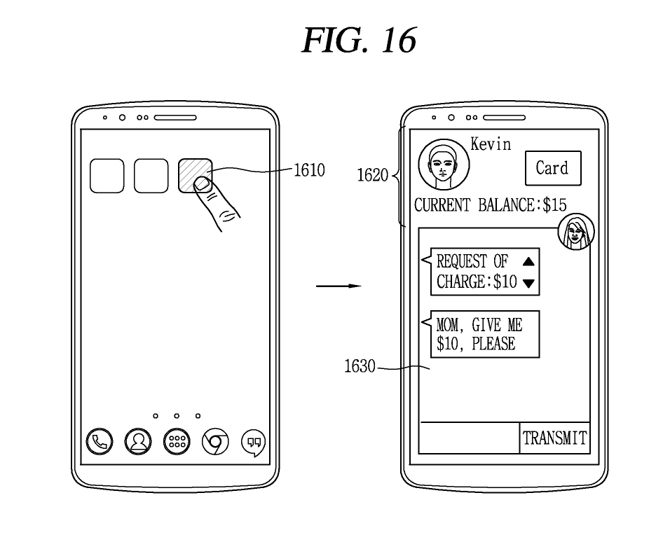

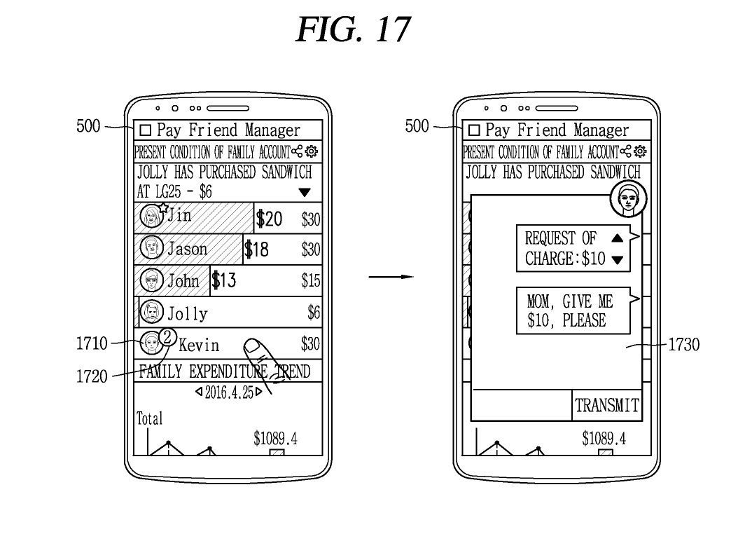

FIGS. 16 and 17 are conceptual diagrams illustrating an exemplary embodiment in which messages are sent/received between the manager and a person to be managed.

That is, FIG. 16 illustrates a mobile terminal of the person to be managed, and FIG. 17 illustrates the mobile terminal of the manager.

Referring to FIG. 16, the person to be managed may execute the family account management application by applying a touch input an icon 1610 of the family account management application.

Accordingly, an execution screen of the family account management application can be output. Information 1620 related to the person to be managed, e.g., a profile picture, a name, an amount of money currently remaining in a card, and the like may be output on the execution screen of the family account management application.

In addition, a conversation window 1630 through which messages can be sent to/received from the manager may be output. The person to be managed may transmit, to the manager, a message requesting the manager to charge an amount of money.

Referring to FIG. 17, when the message is received from the person to be managed as shown in FIG. 16, an icon 1720 indicating the number of received messages may be output in a list 1710 of the person to be managed.

Subsequently, if a touch input is applied to the list 1710 of the person to be managed, a message conversation window 1730 through which the message received from the person to be managed is displayed may be output. After that, the manager may sent/receive messages to/from the person to be managed through the corresponding conversation window 1730.

Meanwhile, the controller 180 may change an available amount of money set for each of the plurality of cards, based on a preset user input is applied to the execution screen of the application.

In addition, the available amount of money for each of the plurality of cards may include a fixed amount of money, which is a specific amount of money automatically set for every specific period, and a variable amount of money, which is an amount of money temporarily set by a user input.

The variable amount of money may be voluntarily set by a request of a person to be managed or the manager.

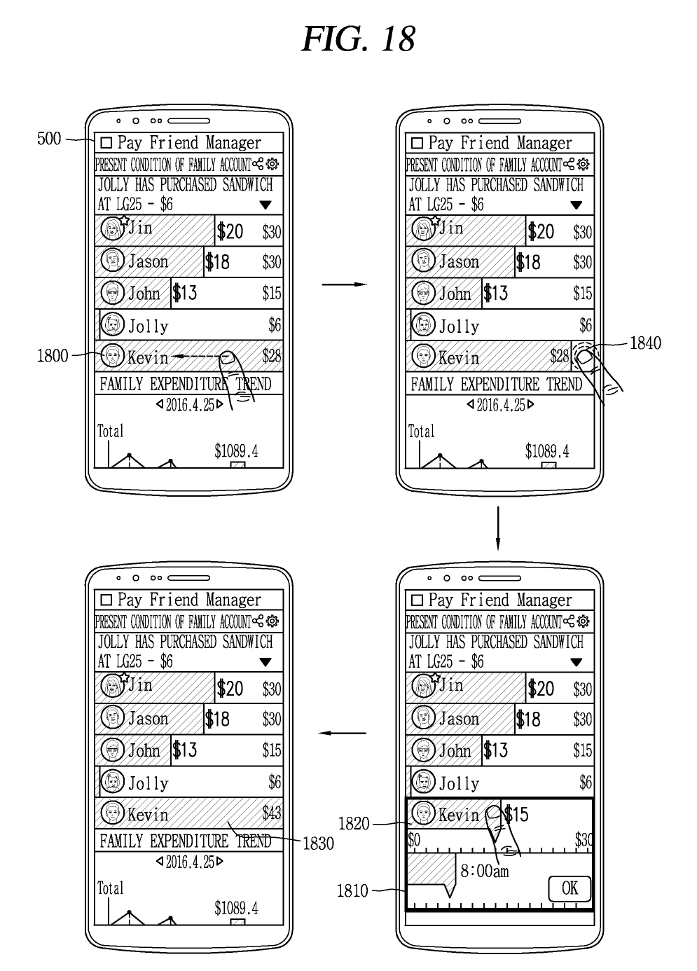

FIG. 18 is a conceptual diagram illustrating an exemplary embodiment in which a variable amount of money to be transferred to a person to be managed is set.

Referring to FIG. 18, if a swipe input in the left direction is applied to a list 1800 of a person to be managed, to which a variable amount of money is to be additionally transferred in addition a fixed amount of money, an icon 1840 for setting the variable amount of money may be output at an end portion of the list 1800.

In addition, if a long touch input is applied to the icon 1840, a setting window 1810 for additionally setting the variable amount of money may be output. As an exemplary embodiment, a variable amount of money, which is to be additionally transferred, may be set by applying a drag input in the left/right direction to a bar on which an amount of money is displayed.

Specifically, if a long touch input is applied to the bar on which the amount of money is displayed, an amount of money ($15) and a graph 1820, which correspond to the point at which the touch input is currently applied, may be output. In addition, a strap handle capable of adjusting the amount of money may be output at the point at which the touch input is applied. After that, the variable amount of money may be increased by applying a drag input in the right direction, or may be decreased by applying a drag input in the left direction.

If the setting of the additional variable amount of money is completed, the variable amount of money may be transferred from after the variable amount of money is set. As another exemplary embodiment, if a long touch input is applied to a bar on which a time at which the fixed amount of money is to be transferred is displayed, a time (8 am) and a graph, which correspond to the point at which the touch input is currently applied, may be output. In addition, a strap handle capable of adjusting the time may be output at the point at which the touch input is applied. Similarly, the time at which the fixed amount of money is to be transferred may be set by applying a drag input in the left/right direction.

If a touch input is applied to a completion icon after the variable amount of money is set as described above, the sum of the fixed amount of money and the variable amount of money may be displayed as a maximum value 1830 of the length of the bar displayed on the list 1800 of the person to be managed.

Meanwhile, if one of the plurality of cards is inserted into the card module 200 in the return mode of the card module 200, the controller 180 may output, on the execution screen of the application, a message notifying that an amount of money remaining after use in the set amount of money has been returned, based on that the amount of money remaining after use in the set amount of money is returned from an account corresponding to the inserted card to the preset account.

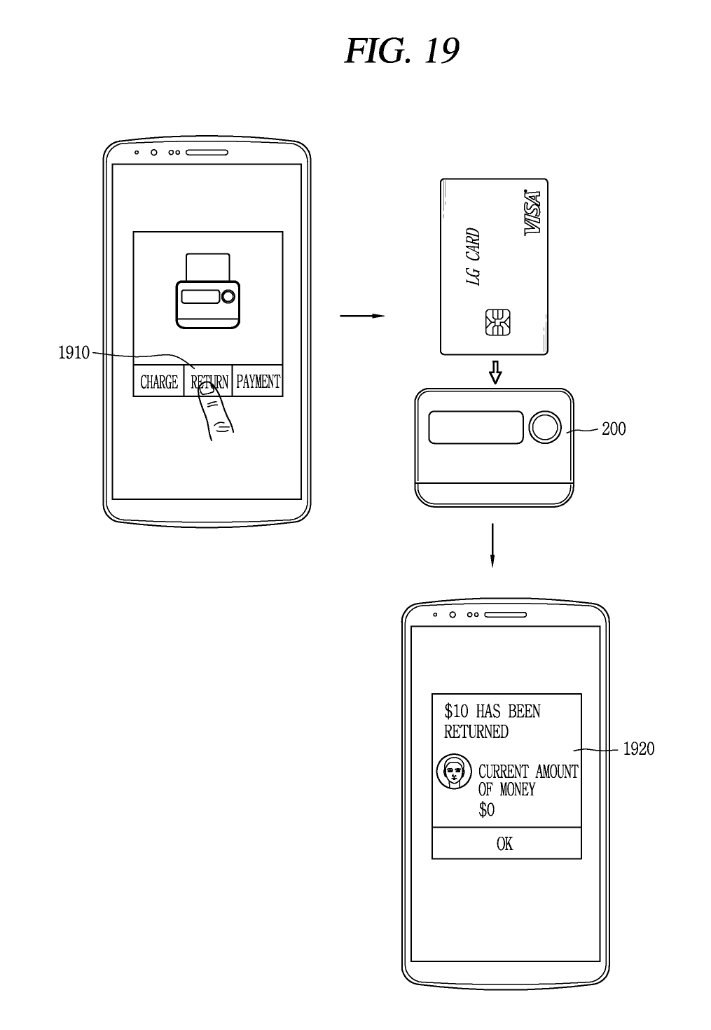

FIG. 19 is a conceptual diagram illustrating an exemplary embodiment in which an amount of money remaining after use is returned from a person to be managed.

That is, FIG. 19 illustrates a mobile terminal of the person to be managed.

Referring to FIG. 19, the mobile terminal of the person to be managed may be connected to the card module 200 through Bluetooth, NFC, Wi-Fi, or the like. Therefore, a screen through which the person to be managed can select a mode of the card module 200 may be output in the mobile terminal of the person to be managed.

As an exemplary embodiment, after a touch input is applied to a “return” icon 1910 among “charge,” “return,” and “payment” icons, a registered card may be inserted into the card module 200.

As another exemplary embodiment, it may be output on the display of the card module that the selected mode is the “return” icon, or a color representing the “return” mode may be emitted from the LED lamp.

Therefore, a message window 1920 notifying that the remaining amount of money has been returned may be output in the mobile terminal of the person to be managed. That is, the amount of money remaining after use may be returned to the preset account (family account).

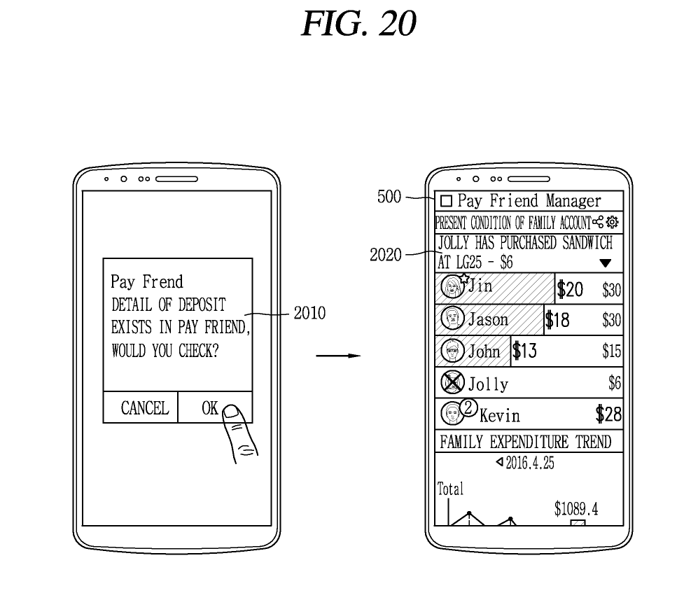

FIG. 20 is a conceptual diagram illustrating an exemplary embodiment in which a notification message notifying that an amount of money has been returned is output.

That is, FIG. 20 illustrates the mobile terminal of the manager.

As the exemplary embodiment continued to FIG. 19, referring to FIG. 20, a message window 2010 notifying that the amount of money remaining after use has been returned by the person to be managed may be output. Subsequently, if a touch input is applied to an “OK” icon, the execution screen 500 of the family account management application may be output.

A message notifying that the amount of money remaining after use has been returned by the person to be managed may be output in an area 2020 displaying the detail of an amount of money used in real time by the card of the person to be managed on the execution screen 500 of the family account management application. As an exemplary embodiment, an amount of money remaining after use, a name of the person to be managed, who has returned, and the like may be displayed.

Meanwhile, based on that an amount of money remaining after user is not returned from a card in which the amount of money remaining after use exists within a preset period, the controller 180 may transmit, to a terminal of a card user, a message for requesting the card user to return the amount of money remaining after use.

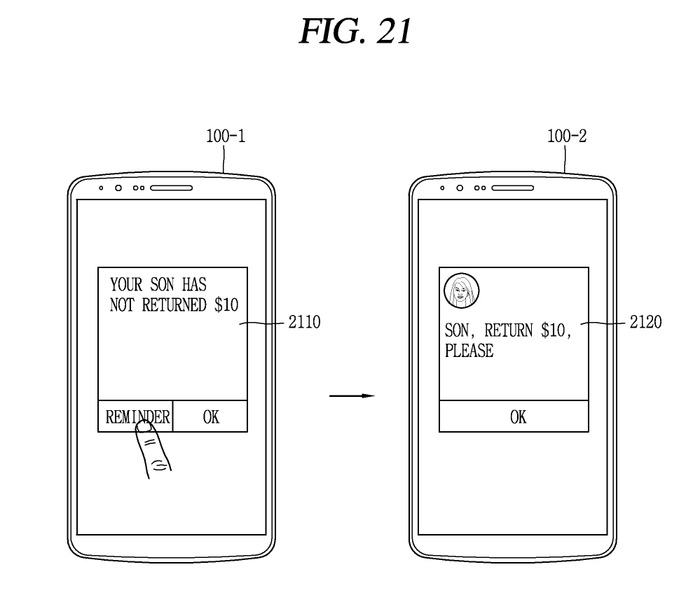

FIG. 21 is a conceptual diagram illustrating an exemplary embodiment in which a reminder message is transmitted when a person to be managed refuses to return an amount of money remaining after use.

Referring to FIG. 21, a message window 2110 notifying that an amount of money remaining after use has not been returned from a card in which the amount of money remaining after use exists may be output in a terminal 100-1 of the manager. As an exemplary embodiment, a user of the card in which the amount of money remaining after use exists, the amount of money remaining after use, and the like may be displayed.

Subsequently, if a touch input is applied to an icon for requesting the card user to return the amount of money remaining after use, a message for requesting the user of the card return the amount of money remaining after use may be transmitted to a terminal 100-2 of the user of the card in which the amount of money remaining after use exists.

As an exemplary embodiment, the message may be directly created by the manager, or a preset common message may be transmitted.

Therefore, a message window 2120 notifying that the amount of money remaining after use is to be returned may be output in the terminal 100-2 of the user of the card in which the amount of money remaining after use exists.

Meanwhile, based on that an amount of money remaining after user is not returned from a card in which the amount of money remaining after use exists within a preset period, the controller 180 may subtract the amount of money that has not been returned from a fixed amount of money, which is a specific amount of money automatically transferred to an account corresponding to the card.

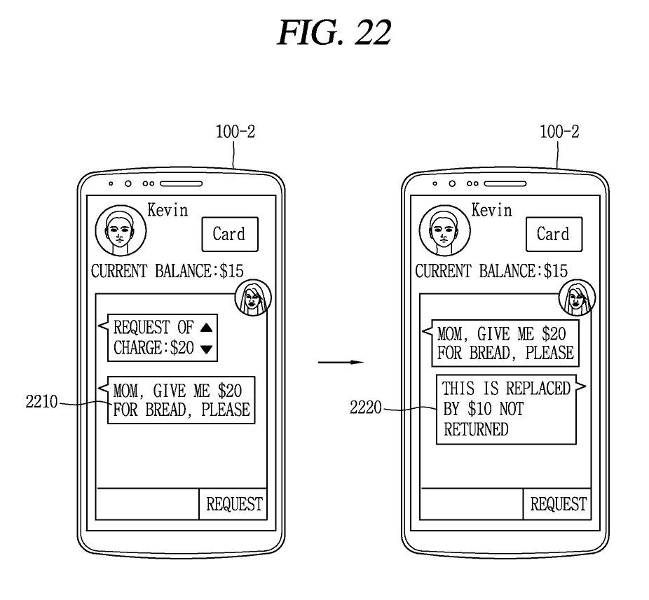

FIG. 22 is a conceptual diagram illustrating an exemplary embodiment in which an additional amount of money is requested to be transferred in a state in which an amount of money remaining after user exists.

Referring to FIG. 22, a message 2200 for requesting an amount of money to be additionally transferred may be created in the terminal 1002 of the user of the card in which the amount of money remaining after use exists to be transmitted to the terminal 100-1 of the manager.

In addition, a profile picture of the user (person to be managed) of the card, the amount of money remaining after use, and the like may be displayed on the execution screen of the family account management application in the terminal 100-2 of the user of the card in which the amount of money remaining after use exists.

Therefore, since the amount of money remaining after use is not returned, a message 2220 notifying that the requested amount of money is replaced by the amount of money remaining after use may be received from the terminal 100-1 of the manager.

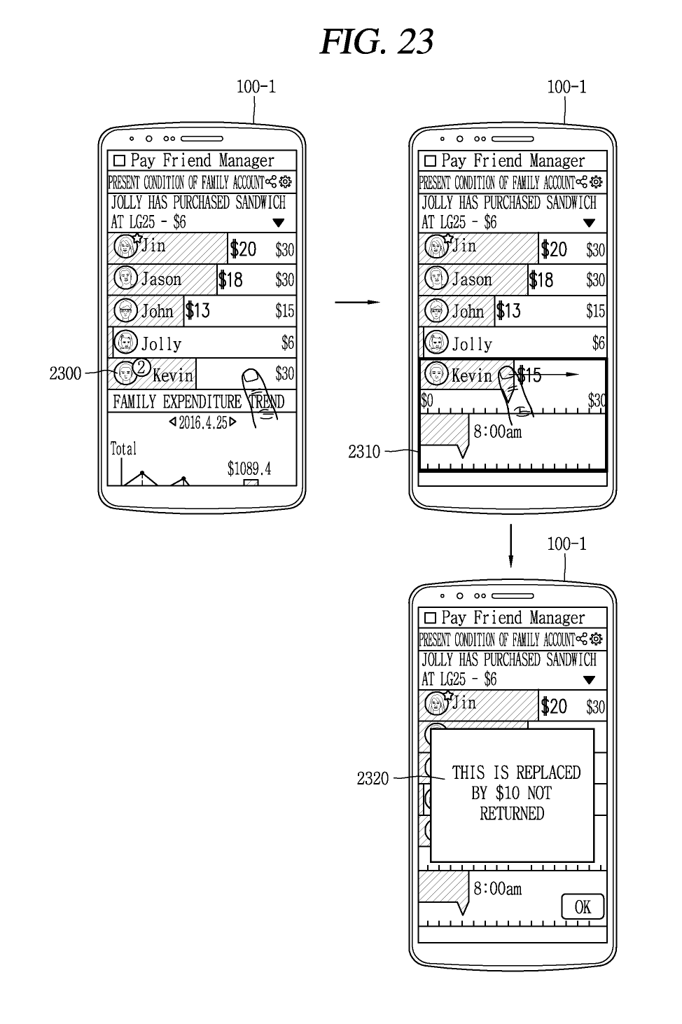

FIG. 23 is a conceptual diagram illustrating an exemplary embodiment in which the amount of money to be additionally transferred is replaced by the amount of money remaining after use, corresponding to the request of additionally transferring the amount of money in FIG. 22.

Referring to FIG. 23, as the person to be managed transmits a message as shown in FIG. 22, the number of received messages may be displayed in a list 2300 of the person to be managed.

Subsequently, if a touch input is applied to the list 2300 of the person to be managed, the received message may be output as shown in FIG. 17.

After that, as shown in FIG. 18, a setting window 2310 for additionally transferring a variable amount of money may be output, and the manager may set a variable amount of money to be additionally transferred by applying a drag input.

As the variable amount of money is set as described above, a message 2320 notifying that, since there exists an amount of money not returned from the person to be managed, the entire or a portion of the set amount of money will be replaced by the amount of money not returned from the person to be managed may be output.

According to the exemplary embodiment of FIG. 23, it is possible to prevent the manager from additionally transferring an amount of money without considering an amount of money not returned, thereby systematically managing money.

Meanwhile, the controller 180 may output a process in which a payment is performed by a card inserted into the card module 200, based on that a user input for selecting a payment by the card module 200 is applied.

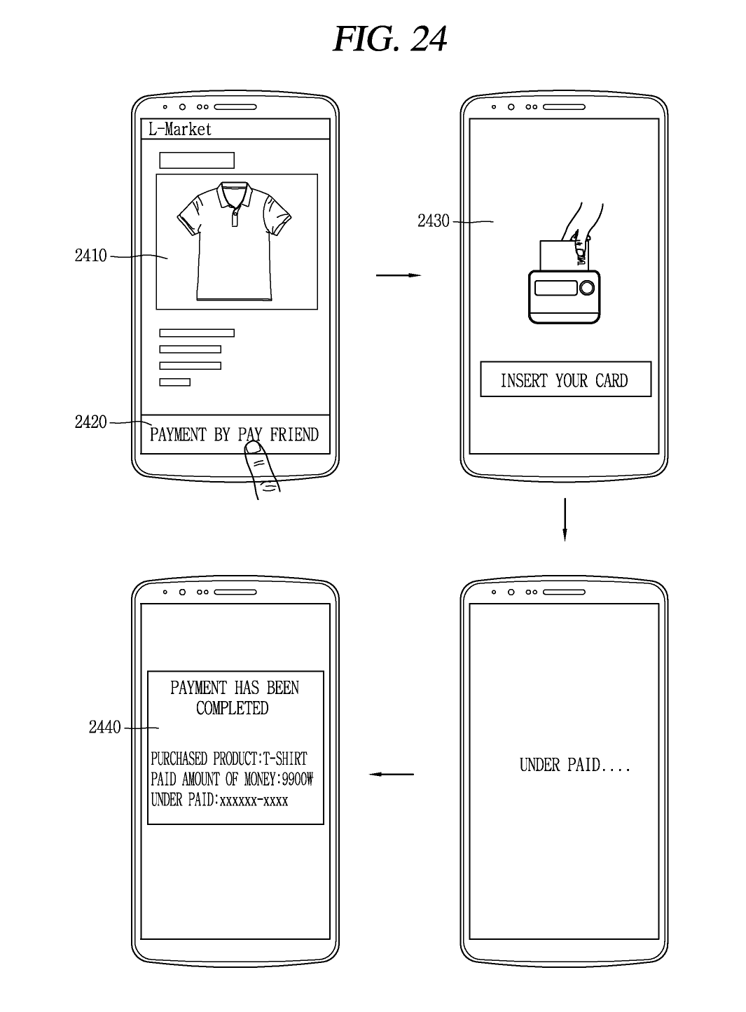

FIG. 24 is a conceptual view illustrating an exemplary embodiment in which a payment is performed by the card module in a state in which the mobile terminal is located close to the card module.

Referring to FIG. 24, a payment by the card module 200 may be selected as a payment after online shopping in the mobile terminal 100 of the manager or a person to be managed. As an exemplary embodiment, a touch input may be applied to a payment icon 2420 by the card module 200 in an online shopping mall page 2410.

Therefore, since the card module 200 is located close to the mobile terminal 100, the card module 200 connected to the mobile terminal 100 through Bluetooth or the like may be automatically set to the payment mode. Alternatively, the card module 200 may be directed set to the payment mode.

After that, a message instructing to insert a card into the card module 200 and a guide image 2430 showing such an operation may be output on the screen 151 of the mobile terminal 100.

In addition, information on an amount of money to be paid, a product to be paid, and the like may be output on the display of the card module 200 connected to the mobile terminal 100.

As the continued exemplary embodiment, as a payment is performed in the state in which the card is inserted into the card module 200, a message notifying that the payment is being performed may be output on each of the screen 151 of the mobile terminal and the display of the card module 200.

After that, as the payment is completed, a payment completion message 2440, e.g., information on a purchased product, a paid amount of money, a distribution address, and the like may be output on the screen 151 of the mobile terminal 100.

In addition, the card inserted into the card module 200 may be automatically extracted by the spring inside the card module 200. Further, the payment completion message may also be output on the display of the card module 200.

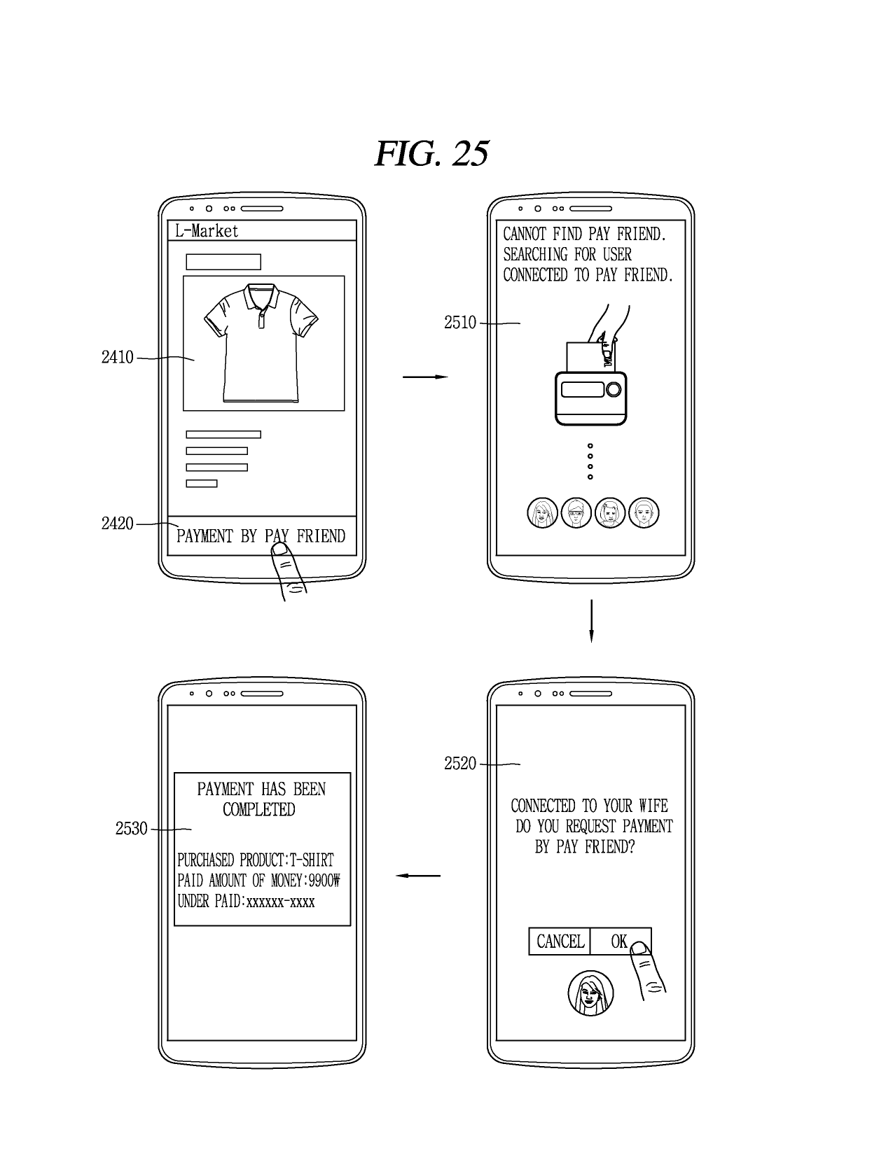

FIG. 25 is a conceptual diagram illustrating an exemplary embodiment in which a payment is performed by the card module in a state in which the mobile terminal is located distant from the card module.

Referring to FIG. 25, a payment by the card module 200 may be selected as a payment after online shopping in the mobile terminal 100 of the manager or a person to be managed. As an exemplary embodiment, a touch input may be applied to a payment icon 2420 by the card module 200 in an online shopping mall page 2410.

Therefore, when the card module 200 is not located close to the mobile terminal 100, a mobile terminal of a person to be managed, which is located close to the card module 200, is searched, and a message 2510 notifying such a state may be output on the screen 151 of the mobile terminal 100.

As a search result, a message 2520 inquiring whether the payment is to be requested may be output in the mobile terminal of the first person to be managed, which is connectable (or being connected) to the card module 200 because the mobile terminal of the first person to be managed is located close to the card module 200. Therefore, if a touch input is applied to an icon for payment request, a message for payment request may be transmitted to the mobile terminal of the first person to be managed.

If the first person to be managed lifts the card module or applies a touch input to an “OK” icon after the first person to be managed, who receives the payment request, identifies the message for payment request, information on an amount of money to be paid, a product to be paid, and the like may be output on the display of the card module 200.

Subsequently, as a payment is performed in the state in which the card is inserted into the card module 200, a message notifying that the payment is being performed may be output on each of the screen 151 of the mobile terminal and the display of the card module 200.

After that, as the payment is completed, a payment completion message 2440, e.g., information on a purchased product, a paid amount of money, a distribution address, and the like may be output in each of the mobile terminal that requests the payment and the mobile terminal that receives the payment request.

In addition, the card inserted into the card module 200 may be automatically extracted by the spring inside the card module 200. Further, the payment completion message may also be output on the display of the card module 200.

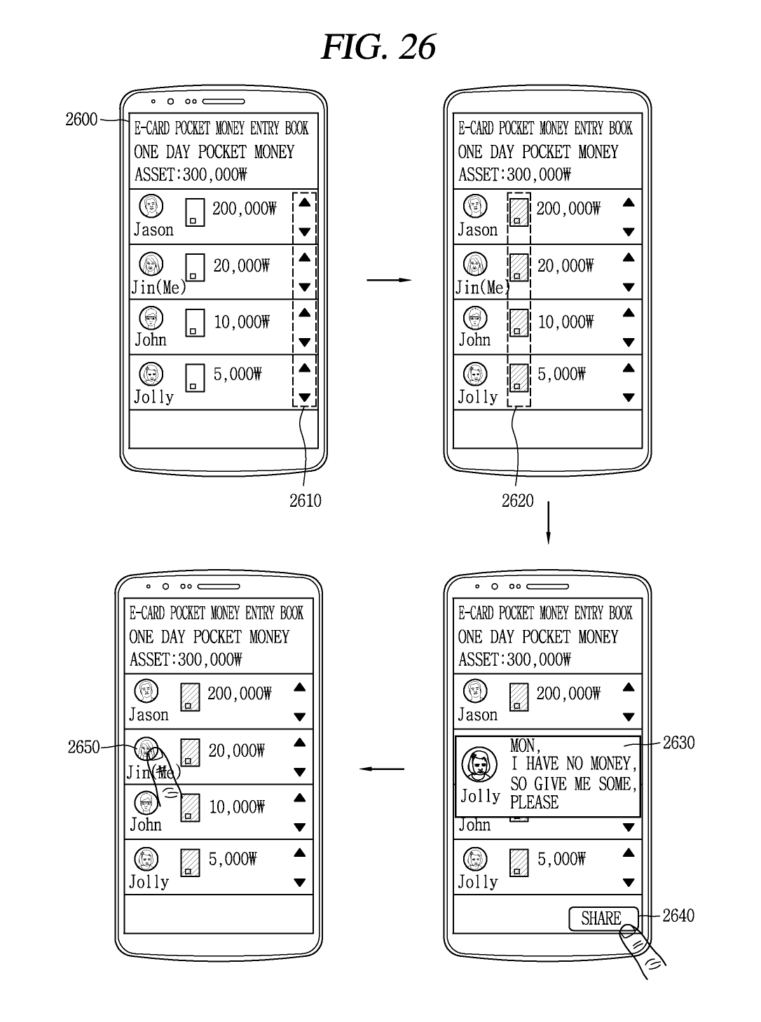

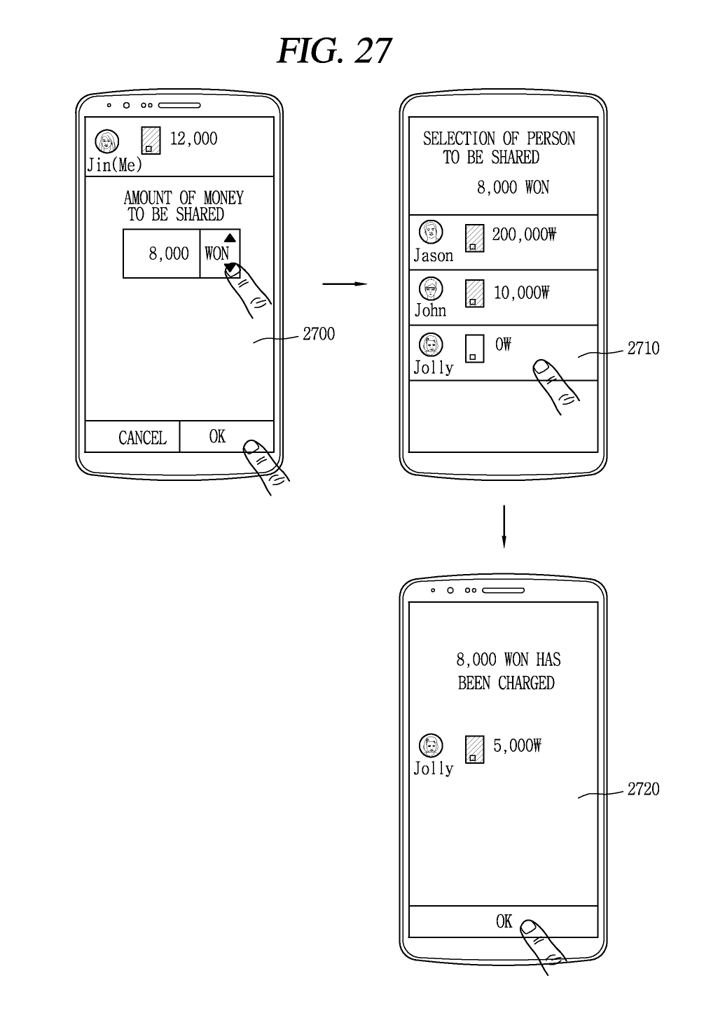

FIGS. 26 and 27 are conceptual diagrams illustrating an exemplary embodiment in which a portion of an amount of money is shared to a person to be managed.

Referring to FIG. 26, an execution screen 2600 of the family account management application may be output in the mobile terminal of the manager. As an exemplary embodiment, an amount of money available by the persons to be managed for a day, a list of the persons to be managed, cards and amounts of money, which are to be used by the persons to be managed, and an icon 2610 for setting an amount of money to be used by each of the persons to be managed may be output on the execution screen 2600 of the family account management application.

As another exemplary embodiment, the execution screen of the family account management application, which is output in the mobile terminal of each of the persons to be managed, is the same as that output in the mobile terminal of the manager, but the icon 2610 for setting an amount of money to be used by each of the persons to be managed may not be output.

After that, if each of the persons to be managed inserts a registered card into the card module 200, an amount of money set to be available may be charged in the registered card. To this end, the amount of money set to be available may be transferred from the family account to an account corresponding to the registered card.

Therefore, an amount of money currently remaining in the card may be displayed as a color graph displayed on an icon 2620 representing a card used by each of the persons to be managed. For example, just after the amount of money is charged, the length of the color graph occupying the entire icon 2620 may be gradually decreased as the card is used.

As still another exemplary embodiment, a message 2630 for charge request, which is received from the mobile terminal of the first person to be managed, may be output. Therefore, after a touch input is applied to a “share” icon 2640, a person to who an amount of money is to be shared, may be selected.

For example, the manager may transfer an amount of money transferred to the card of the manager to an account corresponding to the card used by the first person to be managed by applying a touch input to a list 2650 of the manager.

As the continued exemplary embodiment, referring to FIG. 27, a screen 2700 for setting an amount of money shared to the first person to be managed may be output. As an exemplary embodiment, an amount of money to be shared to the first person to be managed may be set by applying a touch input to an icon for setting the amount of money.

Subsequently, a person to be managed, who is to receive the amount of money, may be selected by applying a touch input a list of the persons to be managed. Therefore, a message 2720 notifying that the amount of money set to be shared is charged to a card of the selected person to be managed may be output.

Meanwhile, as described above, when a portion of the amount of money charged to be available for a day remains, the persons to be managed may return the remaining amount of money by inserting their cards into the card module 200.

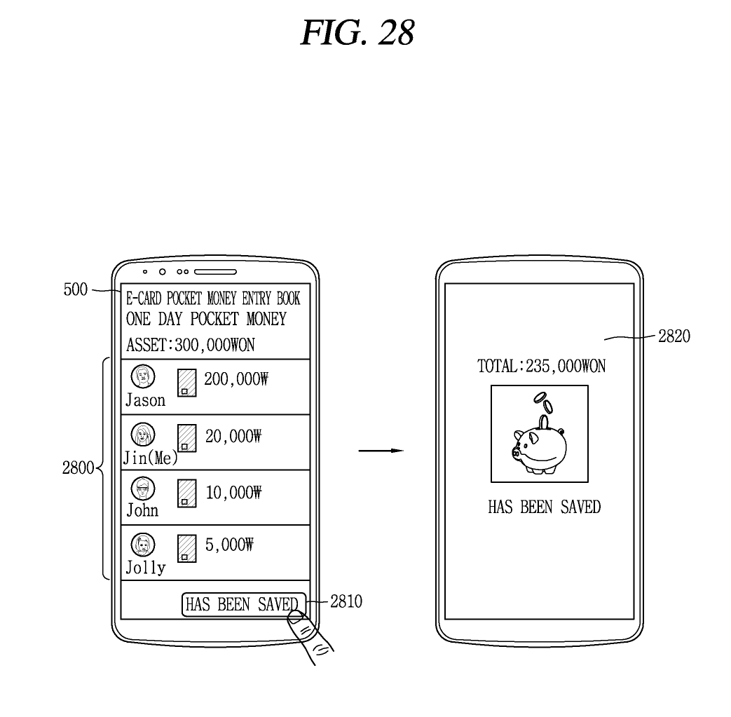

FIG. 28 is a conceptual diagram illustrating an exemplary embodiment in which a returned amount of money is saved.

Referring to FIG. 28, a returned amount of money may be displayed on a list of each of the persons to be managed. Subsequently, if a touch input is applied to a “save” icon 2810, the returned amounts of money may be transferred from the family account to a specific account (saving account). In addition, a message 2820 notifying the transferred amount of money may be output.

Effects of the mobile terminal and the method for controlling the same according to the present disclosure will be described as follows.

According to at least one of the exemplary embodiments of the present disclosure, the manager can manage the consumption expenditure of the persons to be managed by simultaneously checking flows of money spent by the persons to be managed. Specifically, the manager has all authorities related to the control, redemption, payment, etc. of the amount of money transferred to the persons to be managed from the initial registration of the cards.

According to at least one of the exemplary embodiments of the present disclosure, information of a person to be managed, which is to be added, and a card to be used by the person to be managed is simply transmitted, so that it is possible to solve an inconvenience in that information of persons to be added and cards used by the persons should be registered one by one.

According to at least one of the exemplary embodiments of the present disclosure, it is possible to prevent the manager from additionally transferring an amount of money without considering an amount of money not returned, thereby systematically managing money.

According to at least one of the exemplary embodiments of the present disclosure, an amount of money to be automatically transferred for every period is set, so that it is possible to solve an inconvenience in that the amount of money to be automatically transferred should be set for every period.

According to at least one of the exemplary embodiments of the present disclosure, the card module can read both information of a credit card and a smart card, thereby improving compatibility.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a wireless communication unit;
a display; and
a controller configured to:
receive information of a card received by a card module;
cause the display to display an execution screen of an application for setting an amount of money available for each of a plurality of cards of which one is the card received by the card module;
set the amount of money available for each of the plurality of cards based on a user input with regard to the execution screen of the application; and
cause the card module to transfer an amount of money that is to be available in the card from a first account to a second account when the card is received by the card module during a charge mode of the card module, wherein the transfer permits the amount of money to be available in the card.

2. The mobile terminal of claim 1, wherein the controller is further configured to cause the display to display the execution screen when:
a distance between the mobile terminal and the card module is within a preset distance,
a defined touch input is received at an icon of the application, and
a defined master card is received by the card module.

3. The mobile terminal of claim 1, wherein the controller is further configured to:
cause the execution screen of the application to display at least one of:
lists of the plurality of cards or card users,
the set amount of money available for each of the plurality of cards, or
an amount of money currently remaining after use for each of the plurality of cards or for each of the card users.

4. The mobile terminal of claim 3, wherein the controller is further configured to:
exclude some of the plurality of cards or some of the card users respectively from the lists of the plurality of cards or the card users based on a user input received with regard to the some of the plurality of cards or the some of the card users.

5. The mobile terminal of claim 3, wherein the controller is further configured to:
receive information of a new card that is not originally included in the plurality of cards from the card module when the new card is received by the card module; and
add the new card to the lists of the plurality of cards.

6. The mobile terminal of claim 1, wherein the controller is further configured to:
cause the execution screen of the application to display data obtained by analyzing expenditure details of an amount of money used by each of the plurality of cards on a basis of a preset reference.

7. The mobile terminal of claim 1, wherein the controller is further configured to:
set a fixed amount of money to be transferred to an account corresponding to a selected card among the plurality of cards, and set a period in which a fixed amount of money is to be transferred to the account corresponding to the selected card, based on a user input received with regard to the execution screen of the application.

8. The mobile terminal of claim 1, wherein the controller is further configured to:
cause the display to display a notification message indicating to check an expenditure detail of an amount of money used by a card among the plurality of cards.

9. The mobile terminal of claim 1, wherein the controller is further configured to:
restrict use of a selected card among the plurality of cards, based on input received with regard to the execution screen of the application.

10. The mobile terminal of claim 1, wherein the controller is further configured to:
cause the display to display a conversation window to communicate messages with a mobile terminal of a selected card user based on input received with regard to the execution screen of the application.

11. The mobile terminal of claim 1, wherein the controller is further configured to:
change the amount of money available for each of the plurality of cards based on input received with regard to the execution screen of the application.

12. The mobile terminal of claim 1, wherein the amount of money available for each of the plurality of cards includes a fixed amount of money, which is a specific amount of money automatically set for every specific period, and a variable amount of money, which is an amount of money temporarily set by an user input.

13. The mobile terminal of claim 1, wherein the controller is further configured to:
cause the display to display on the execution screen of the application a message notifying that an amount of money remaining after a set amount of money has been returned when the card is received by the card module while in a return mode.

14. The mobile terminal of claim 13, wherein the controller is further configured to:
transmit a message for a return request to a mobile terminal of a user of the card when the amount of money remaining is not returned from a card within a preset period,

15. The mobile terminal of claim 13, wherein the controller is further configured to:
subtract an amount of money not returned from a specific amount of money transferred to an account corresponding to the card.

16. The mobile terminal of claim 1, wherein the controller is further configured to:
perform payment by a card received at the card module based on a user input for selecting a payment.

17. The mobile terminal of claim 1, wherein the card module includes a card information reader unit configured to receive information of a received card.

18. The mobile terminal of claim 1, wherein the card module is set to one mode among a plurality of modes based on received user input, wherein the plurality of modes include:
a charge mode for allowing an amount of money to be transferred from a preset account to an account corresponding to the card;
a return mode for allowing an amount of money to be returned from an account corresponding to the inserted card to the preset account; and
a payment mode for allowing a payment to be performed using the card.

19. The mobile terminal of claim 18, wherein the card module includes an output unit configured to display the set mode.

20. A method for controlling a mobile terminal, the method comprising:
receiving information of a card received by a card module;
displaying, on a display of the mobile terminal, an execution screen of an application for setting an amount of money available for each of a plurality of cards of which one is the card received by the card module;
setting the amount of money available for each of the plurality of cards based on a user input with regard to the execution screen of the application; and
transferring an amount of money that is to be available in the card from a first account to a second account when the card is received by the card module during a charge mode of the card module, wherein the transfer permits the amount of money to be available in the card.
